(19) United States
(12) Patent Application Publication
(10) Pub. No.: US 2024/0095616 A1
(43) Pub. Date: Mar. 21, 2024

(54) AUTOMATICALLY AND DYNAMICALLY MANAGING TASK BASED SCHEDULING AND OPERATIONS FOR DISTRIBUTION WAREHOUSES

(71) Applicant: AutoScheduler.AI LP, Franklin, TN (US)

(72) Inventors: Andrew Gibson, Rogers, AR (US); Agustin Pecorari, Buenos Aires (AR); Felipe Santos Boffo, Porto Alegre (BR); Keith D. Moore, Leander, TX (US)

(21) Appl. No.: 18/369,679

(22) Filed: Sep. 18, 2023

Related U.S. Application Data
(60) Provisional application No. 63/408,008, filed on Sep. 19, 2022.
(60) Provisional application No. 63/462,237, filed on Apr. 26, 2023.
(60) Provisional application No. 63/538,969, filed on Sep. 18, 2023.

(51) Int. Cl. G06Q 10/0631; G06Q 10/04; G06Q 10/087

(52) U.S. Cl. CPC G06Q 10/06311; G06Q 10/04; G06Q 10/087

(57) ABSTRACT

A system, method and/or computer usable program product for automatically and dynamically planning and executing schedules and operations of a distribution warehouse locality including accessing a set of customer orders for fulfillment from the distribution warehouse locality within a predetermined timeframe, each customer order including a priority for fulfillment; accessing current inventory levels for the distribution warehouse locality; accessing expected shipments of inventory to the distribution warehouse locality; accessing a set of expected labor resources at the distribution warehouse locality for fulfilling the set of customer orders within the predetermined timeframe; automatically generating a set of tasks for completing each customer order; automatically optimizing an allocation of the set of tasks with the set of expected labor resources for each customer order; automatically scheduling the allocated set of expected labor resources and the set of tasks for fulfilling the set of customer orders; accessing an identified set of actors associated with the set of expected labor resources within a second timeframe; automatically optimizing an allocation of the set of tasks with the identified set of actors for fulfilling the set of customer orders within the second timeframe, the optimization including reducing travel by the set of actors; and automatically providing a set of signals describing the optimized allocated set of tasks to the identified set of actors.

### PRIORITY CLAIM

This application claims priority to U.S. Provisional Patent Application No. 63/408,008, filed Sep. 19, 2022, entitled “AUTOMATICALLY AND DYNAMICALLY MANAGING DISTRIBUTION WAREHOUSE SCHEDULING AND OPERATIONS”, with Attorney docket number AS2201US01P; to U.S. Provisional Patent Application No. 63/462,237, filed Apr. 26, 2023, entitled “AUTOMATICALLY AND DYNAMICALLY MANAGING DISTRIBUTION WAREHOUSE SCHEDULING AND OPERATIONS”, with Attorney docket number AS2202US01P; and to U.S. Provisional Patent Application No. 63/538,969, filed Sep. 18, 2023, entitled “DYNAMICALLY OPTIMIZING INVENTORY LEVELS AMONG MULTIPLE DISTRIBUTION WAREHOUSES THROUGH SHIPMENT REALLOCATIONS AND TRANSFER SHIPMENTS”, with Attorney docket number AS2203US01P; the contents of each of the foregoing which are incorporated by reference herein in their entirety.

### BACKGROUND

### Technical Field

A system and method relate generally to managing distribution warehouse operations, and more specifically to a computer implemented system and method for automatically and dynamically planning and executing task based scheduling and operations for distribution warehouses.

### Description of Related Art

A distribution warehouse may be utilized to receive, store, repackage and ship goods from suppliers to customers. Suppliers may be manufacturers, assemblers or other producers of goods. Suppliers may also be other providers of goods that utilize distribution warehouses such as resellers, other distributers, ports or other types of non-producers. Customers may be end use customers, retailers, other distributers, etc. In summary, many types of suppliers and customers may utilize a distribution warehouse or set of distribution warehouses.

Fulfilling orders quickly and efficiently from a distribution warehouse onto handling units for shipping is an important part of the operation of many businesses and industries. It is through this process that goods, such as items and other products, may be shipped or otherwise provided for storage in a distribution warehouse, then picked and stacked onto handling units for shipment to customers. There is a need to increase productivity and drive greater efficiency throughout the process. For example, in a consumer products distribution warehouse, to eliminate travel around the distribution warehouse, it's desirable to pick two or more customers' orders at the same time. This may significantly reduce time and effort for order selection, but mistakes are expensive. Even in a “goods to picker” environment, errors may be frequent and are generally increased with concurrent order selection of multiple orders at the same time due to the increased complexities involved.

Supply chains have complexities with constraints, variables, metrics, and performance objectives. In addition, supply chains may have greater variability and unpredictability over time. That is, traffic on those supply chains may vary significantly on a daily basis due to changing conditions outside the supply chain. For example, climatic changes can affect a variety of factors such as highly variable demands for certain items at certain destinations. For another example, labor disruptions at a transportation provider can rapidly affect the availability of transportation units at certain transportation origins. As a result, optimizing the flow of goods through such variable supply chains is also increasingly a complex and difficult task.

Broadly speaking, supply chain management is the management of the flow of goods and services from processing raw materials to providing final products to customers. There are many organizations that utilize a variety of supply chain management tools, either developed internally or acquired from third party vendors. For example, Amazon.com Inc. and Walmart Inc. are very large organizations known for their supply chain management expertise that provide a competitive advantage in the marketplace. In addition, a variety of third party vendors, including SAP SE, Infor Inc., Blue Yonder Inc., Kinaxis Inc., Logility Inc., Bluecrux CVBA, E2open LLC, Manhattan Associates, Transportation|Warehouse Optimization (T|WO), etc. have developed a variety of software tools for managing supply chains. These tools range from accounting systems for tracking the supply chain assets and expenses to planning tools for managing the shipments of goods. Example products are SAP APO (Advanced Planner and Optimizer), Kinaxis RapidResponse and the T|WO AutoO2 and AutoCDO software tools.

Distributed Order Management Systems (DOM) are known for managing future demand by allocating order fulfillment to the most optimal location. For example, if an order is placed for a set of goods, a DOM system may allocate fulfilling that order as well as other orders by scheduling a shipment from warehouse to a customer based on warehouse proximity and current inventory supply availability.

There are many warehouse management systems (WMS) implemented as software available on the market such as SAP Extended Warehouse Management by SAP, Oracle Fusion Cloud Warehouse Management by Oracle, Blue Yonder Warehouse Management by Blue Yonder, Microsoft Dynamics 365 by Microsoft, K.Motion Warehouse Advantage and K.Motion Enterprise 3PL by Korber Supply Chain, Manhattan Associates Warehouse Management for IBM i(WMi) and Warehouse Management for Open Systems by Warehouse Associates, Click Reply by Reply, TECSYS Warehouse Management by Teksys, Reflex WMS by Hardis Group, SnapFulfil by Synergy Logistics, Vin eRetail WMS by Vinculum, Infor WMS by Infor, EPG LFS by Ehrhardt+Partner Group, vTradEX Warehouse Management System by vTradEx, Microlistics WMS by Microlistics, etc. These types of systems can range from recording the arrival and departure of inventory to managing labor and space resource utilization and material flows towards fulfilling customer orders. They may include a basic inventory system, a more advanced system which analyzes inventory levels and track time and labor spent in various activities, to a system that can communicate with other systems.

For example, Blue Yonder's WMS utilizes inventory management including processing inbound and outbound inventory, managing inventory stock levels as well as managing labor resources by directing work to personnel on the floor. Planners and taskers inside of the facility are responsible for working with the Blue Yonder WMS to allocate inventory to shipments, wave out work, and release tasks into a “work queue”, in which a combined zoning strategy and task prioritization inside of the WMS “directs” work to the appropriate employee based on their permissions, proximity, and the task priority (known as the 3 P's in warehousing).

### SUMMARY

A system, method and/or computer usable program product for automatically and dynamically planning and executing schedules and operations of a distribution warehouse locality including accessing a set of customer orders for fulfillment from the distribution warehouse locality within a predetermined timeframe, each customer order including a priority for fulfillment; accessing current inventory levels for the distribution warehouse locality; accessing expected shipments of inventory to the distribution warehouse locality; accessing a set of expected labor resources at the distribution warehouse locality for fulfilling the set of customer orders within the predetermined timeframe; automatically generating a set of tasks for completing each customer order; automatically optimizing an allocation of the set of tasks with the set of expected labor resources for each customer order; automatically scheduling the allocated set of expected labor resources and the set of tasks for fulfilling the set of customer orders; accessing an identified set of actors associated with the set of expected labor resources within a second timeframe; automatically optimizing an allocation of the set of tasks with the identified set of actors for fulfilling the set of customer orders within the second timeframe, the optimization including reducing travel by the set of actors; and automatically providing a set of signals describing the optimized allocated set of tasks to the identified set of actors.

### BRIEF DESCRIPTION OF THE DRAWINGS

Embodiments of a system and method for automatically and dynamically planning and executing distribution warehouse scheduling and operations may be better understood, and its numerous features and advantages made apparent to those skilled in the art by referencing the accompanying drawings. The use of the same reference number throughout the several figures designates a like or similar element.

FIG. 1 depicts a high level system flow diagram of various modules automatically and dynamically managing a flow of goods from supplier(s) through distribution warehouse site(s) to customer(s), in which various embodiments of the present disclosure may be implemented.

FIG. 2 depicts a high level block diagram of a system for automatically and dynamically planning and executing distribution warehouse scheduling and operations for managing the flow of goods from supplier(s) to customer(s), in which various embodiments of the present disclosure may be implemented.

FIG. 3 depicts a flow diagram of the constraints and capacities planning module identifying various constraints and capacities of a distribution warehouse site, in which various embodiments of the present disclosure may be implemented.

FIG. 4 depicts a flow diagram of the task creation module generating a set of tasks to handle and fulfill incoming and outgoing shipments of a distribution warehouse site, in which various embodiments of the present disclosure may be implemented.

FIG. 5 depicts a flow diagram of the sequence actor assignment module optimizing the generated set of tasks to handle and fulfill incoming and outgoing shipments of a distribution warehouse site, in which various embodiments of the present disclosure may be implemented.

FIGS. 6A and 6B depict diagrams of a graphical user interface page providing a schedule optimization such as by optimizer 250, in which various embodiments of the present disclosure may be implemented.

FIG. 7 depicts a flow diagram of the spatial assignment module spatially optimizing the generated set of shipments, in which various embodiments of the present disclosure may be implemented.

FIG. 8 depicts a flow diagram of the schedule execution module implementing a planned schedule for managing operations of a distribution warehouse to handle incoming and outgoing shipments including reallocations and transfers, in which various embodiments of the present disclosure may be presented.

FIG. 9 depicts a block diagram of an illustrative data processing system in which various embodiments of the present disclosure may be implemented.

FIG. 10 depicts a block diagram of an illustrative network of data processing systems in which various embodiments of the present disclosure may be implemented.

### DETAILED DESCRIPTION

Processes and devices may be implemented and utilized for automatically and dynamically planning and executing distribution warehouse scheduling and operations. These processes and apparatuses may be implemented and utilized as will be explained with reference to the various embodiments below.

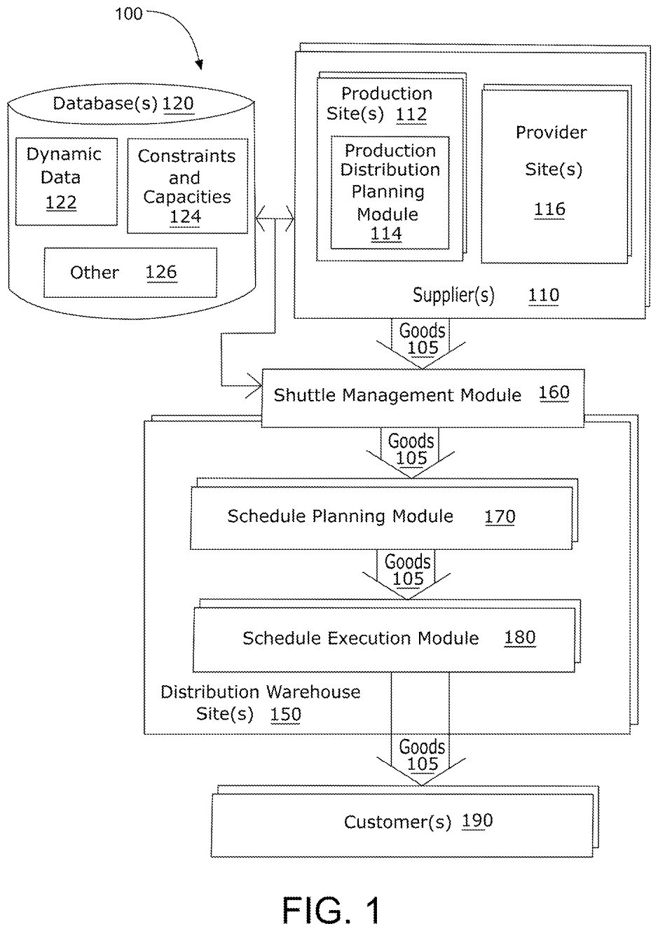

In at least one embodiment, a system and method is provided for automatically and dynamically planning and executing distribution warehouse scheduling and operations. FIG. 1 depicts a high level system flow diagram 100 of various modules automatically and dynamically managing a flow of goods 105 from supplier(s) 110 through distribution warehouse site(s) 150 to customer(s) 190, in which various embodiments of the present disclosure may be implemented. Modules may include software systems or other automated systems for dynamically managing the flow of goods as described herein. Supplier(s) 110 may include one or more suppliers including production site(s) 112 that may manufacture goods and other provider site(s) 116 that may distribute or otherwise provide goods manufactured by other entities. Supplier site(s) 110 and distribution warehouse(s) 150 may utilize database(s) 120 as may be described in greater detail below. Production site(s) 112 may be given access to more or different data within database(s) 120 such as described herein.

For ease of reference, supplier(s) 110, production site(s) 112, other provider site(s) 116, database(s) 120, distribution warehouse site(s) 150 and customer(s) 190, as well as other components of the present embodiments described herein, may be referred to in the singular, plural or as a set thereof without limiting the various embodiments to singular or plural implementations as may be appreciated by one of ordinary skill in the art. In addition, multiple sites located on the same campus (i.e., multiple sites in close proximity to each other, including within the same large building or warehouse) may be referred to as a site or as a locality without limiting the various embodiments to a site or campus implementation as may be appreciated by one of ordinary skill in the art. Furthermore, as may be appreciated by one of ordinary skill in the art, a given supplier site (e.g., a production site) may be located at the same site or supplier campus as a given distribution warehouse site or distribution campus. A supplier site or campus, a production site or campus, or a provider site or campus may be collectively referred to herein as a supplier locality, production locality or provider locality, respectfully. Other variations of the organization of the various entities and modules may be utilized in alternative embodiments, as may be appreciated by one of ordinary skill in the art.

In the present embodiment, there are a set of modules depicted for automatically and dynamically managing a flow of goods 105 from suppliers 110 to distribution warehouses 150 and onto customers 190. These modules may include a production distribution planning module 114, an inventory shuttle management module 160, a schedule planning module 170 and a schedule execution module 180. Each of these modules may contain other modules such as described herein. Each of these modules may be implemented locally, at a central location, and/or in the cloud such as a software as a service implementation. At a high level, production distribution planning module 114 may manage production and shipping from production sites 112 to distribution warehouse sites 150. Shuttle management module 160 may manage relocating shipments of goods 105 from suppliers 110 to distribution warehouses 150 as well as transfers of goods 105 (i.e., current inventory) between distribution warehouses 150. In the present embodiment, shuttle management module 160 may manage moving inventory between distribution warehouse sites of a given campus, but not between campuses. This limitation on shuttle management may be due to the distances involved as well as to simplify such management of inventory. Alternative embodiments may allow shuttle management between distribution warehouse sites of different distribution campuses. Schedule planning module 170 may manage scheduling distribution warehouse operations including receiving, storing, picking, repackaging and shipping of goods to customers. That is, schedule planning module 170 may utilize ongoing inventory levels (e.g., current, incoming and outgoing) as well as distribution warehouse capacities and constraints (e.g., site, labor and space) to generate a planned schedule for fulfilling customer orders. Schedule execution module 180 may then allocate a set of individual tasks with a set of resources to implement the planned schedule from schedule planning module 170.

In the present embodiment, a separate instance of schedule planning module 170 and schedule execution module 180 may be run for each distribution warehouse site. A distribution warehouse site may be a separate building or even a distinct portion of a given building. For example, one large warehouse may be managed as two sites where the two sites are run essentially separate from each other, such as where one portion of the building is for a given product line with a separate set of customers from another product line stored in another portion of the building.

In the present embodiment, each of the modules described above may be executed independently. They may also be executed with different timeframe projections and at different frequencies. This may allow for different implementations of these modules across different entities including suppliers, distribution warehouses and customers. This may also allow for the utilization of existing infrastructure within the various entities. However, the output of a given module may be stored in databases 120 or elsewhere for utilization by the other modules. In alternative embodiments, these modules may be more tightly coupled and implemented concurrently as may be appreciated by one of ordinary skill in the art. Each of these modules of the current implementation is described in greater detail below.

Database 120 may be utilized to store various types of data for utilization by production distribution planning module 114, shuttle management module 160, schedule planning module 170 and schedule execution module 180 as well as other elements and entities as needed. Database 120 may be a single database or multiple databases and may be located on-site, remotely and/or in a cloud system. Database 120 may utilize appropriate data security controls to manage access to any data stored therein. For example, some distribution planning modules 114 of certain production sites 112 may be provided limited access to selected data for utilization of that selected data for managing the production and shipping of those production sites to distribution warehouse sites 150. Database 120 may include dynamic data 122 which includes data that may vary frequently such as incoming supplier shipments, outgoing customer orders, current inventory, etc. Database 120 may also include constraints and capacities 124 which includes site constraints, actor and action constraints, types of tasks which may be created for performance by actors (also referred to herein as labor resources and workers), automated machines (i.e., robots or other automated equipment which may also be included as labor resources), as well as other types of data which may generally be more static. Other types of data such as current labor resources (i.e., how many and which actors are currently on-site), customer order fulfillment penalties and rewards (e.g., delayed unloading or delayed customer shipments), etc. may be stored in database 120, either in dynamic data 122, constraints and capacities 124 or in other databases or files 126 within of in conjunction with database 120. As may be appreciated by one of ordinary skill in the art, other embodiments may utilize alternative ways to distribute and organize data utilized for utilization as needed.

Each production site 112 may include production distribution planning module 114, also referred to herein as a make and ship module, for managing production and shipping as needed to fulfill customer and distribution warehouse orders. That is, customer and distribution warehouse orders may be tied back to or otherwise associated with a dynamic known production schedule and a shipping schedule generated by production distribution planning module 114 including specifying trailers or other shipping containers needed per shipping lane for up to several days ahead of time. This dynamic automated schedule may be utilized to optimize trailer or other shipping container usage for a given production site or campus in real-time. Although the present embodiment is directed to each production site having a separate production distribution planning module, there may be a single production distribution planning module for all production sites, for all productions sites for a given product or product category, or for all production sites for a given production campus or locality. Production distribution planning module 114 may utilize a variety of current and projected information from database 120 to manage production and shipping including orders from customers 190, production constraints and capacities of production site 112, shipping constraints and capacities of production site 112, production and shipments from other production sites 112, shipment receiving constraints and capacities of distribution warehouse site 150, inventory capacities and constraints of distribution warehouse 150, inventory safety stock requirements of distribution warehouse 150, etc. To accomplish this, production distribution planning module 114 may access these types of data from database 120 including customer orders (which may include a due date or other priority for completing each customer order) from dynamic database 122 as well as constraints and capacities of production site 112 and distribution warehouse 150 from constraints and capacities database 124. As may be appreciated by one of ordinary skill in the art, there may be several factors utilized to indicate a priority for a given customer order including due date, ship by date, a priority based on the type of customer, the entity that captured the order, whether any additional payments were made by the customer to increase the customer order priority, etc.

Each distribution warehouse site 150 may include schedule planning module 170 for managing the scheduling of distribution warehouse operations including receiving goods from suppliers, storing the received goods, picking the stored and/or received goods, repackaging the picked goods, loading the repackaged goods onto shipping containers (e.g., truck trailers or railroad cars), and shipping of the loaded goods to customers 190. That is, schedule planning module 170 may efficiently schedule the utilization of labor and equipment resources to receive and unload incoming goods, storing those goods within the distribution warehouse, picking and loading those stored and received goods as needed in accordance with customer orders, and shipping the picked goods to meet those customer orders, all automatically and dynamically. This schedule planning may take into account the various capacities and constraints of labor and equipment, capacities and constraints of the distribution warehouse, penalties and other negative consequences of not meeting customer orders in a timely manner, as well as any rewards that may apply if certain conditions are met. Schedule planning module 170 may utilize a variety of current and projected information from database 120 including scheduled incoming shipments, on-site trailer (or other container) storage, trailer unloading and loading capacities and constraints, labor and equipment capacities and constraints, customer orders, etc. Although the present embodiment is directed to each distribution warehouse site having a separate schedule planning module, there may be a single schedule planning module for all distribution warehouse sites, for all distribution warehouse sites for a given product or product category, or for all distribution warehouse sites for a given distribution warehouse campus.

Each distribution warehouse site 150 may also include a schedule execution module 180 for managing a set of individual tasks with a set of resources to implement the planned schedule from schedule planning module 170 given resource locations and planned movements in the building. That is, schedule execution module 180 may take the planned schedule of the utilization of labor and equipment resources from schedule planning module 170, and efficiently schedule a set of tasks for the labor and equipment resources to execute that planned schedule. This schedule of the set of tasks, referred to herein as an execution schedule, may be provided to the labor and equipment resources in real-time and just-in-time such as in directed work. That is, each task may be provided to a labor resource just as the prior task has been completed. This may include receiving and unloading incoming goods, storing those goods within the distribution warehouse, picking those stored and received goods as needed in accordance with customer orders, and shipping the picked goods to meet those customer orders, all automatically and dynamically.

This schedule execution may take into account the various capacities and constraints of the distribution warehouse as well as penalties and negative consequences of not meeting customer orders in a timely manner as well as any rewards that may apply if certain conditions are met. Schedule execution module 180 may utilize a variety of current and projected information from database 120 including scheduled incoming shipments, on-site trailer (or other container) storage, trailer unloading and loading capacities and constraints, labor and equipment capacities and constraints, customer orders, etc. Schedule execution module 180 may also utilize additional task specific information from database 120 including the qualifications and capabilities of labor resources, required qualifications for labor resources to operate various equipment resources, time needed to travel between tasks, etc. Although the present embodiment is directed to each distribution warehouse site having a separate schedule execution module, there may be a single schedule execution module for all distribution warehouse sites, for all distribution warehouse sites for a given product or product category, or for all distribution warehouse sites for a given distribution warehouse campus.

As may be appreciated by one of ordinary skill in the art, other configurations of modules may be implemented to enable the automatic and dynamic management of distribution warehouse operations. In addition, each module may include multiple modules to implement the various functions described herein.

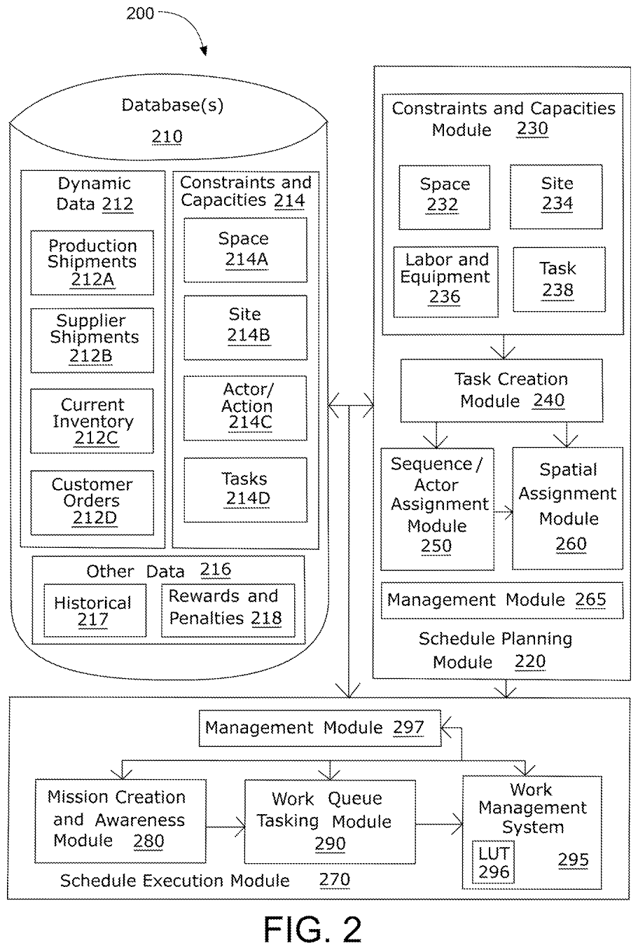

FIG. 2 depicts a high level block diagram of a scheduling system 200 for automatically and dynamically planning and executing distribution warehouse scheduling and operations for managing the flow of goods from supplier(s) to customer(s), in which various embodiments of the present disclosure may be implemented. In this embodiment, scheduling system 200 includes a set of databases 210 and two main modular subsystems, a schedule planning module 220 and a schedule execution module 270. Databases 210, schedule planning module 220 and schedule execution module 270 may respectively correspond to database(s) 120, schedule planning module 170 and schedule execution module 180 depicted with reference to FIG. 1. These elements may utilize the shipping, reallocation and transfer information from production distribution planning module 114 and shuttle management module 160 as described with reference to FIG. 1.

In summary, schedule planning module 220 may automatically and dynamically schedule all receipts of goods, all shipments of goods, all labor and equipment resources, and all inventory movement and storage for a distribution warehouse site or campus while taking into account the various site, space, labor and equipment capacities and constraints. This schedule planning may be provided as a general allocation of labor, inventory and space resources to handle all receipts, shipments and inventory over a period of time. That is, schedule planning module 220 may allocate labor resources to different equipment and task types for fulfilling customer orders, not individual people or specific automated equipment to specific tasks, based on the capacities of the available labor resources, inventory to fulfill the scheduled customer orders, and priority of the customer orders. This planned schedule may include which shipment unloading and loading areas as well as which staging areas to utilize to accomplish the planned schedule. Schedule execution module 270 may then subsequently schedule and direct the planned schedule on a task by task basis (e.g., directed work) based on the proximities and capabilities of individual resources. Schedule execution module 270 may operate by taking the revised output plan from the schedule planning module 220, which includes task start and end times as well as high-level personnel assignments (i.e. 3 persons of a given actor type case picking these 5 orders from 10:00 to 11:15), and modifies the WMS work queue priorities to optimally sequence work to the appropriate actors given where they are and the work requirements. This work queue modification can consider required task start times, end times, and the starting and ending location of all personnel related to each task. The output of the schedule execution module 270 is a reprioritized work queue inside of a warehouse management system that is automatically “directed” out to the floor via automated systems with no human intervention involved.

As a simplified example which may be managed by schedule planning module 220, there may be two customer orders for company A and company B, respectively, needing to be fulfilled (i.e., picked, repackaged, loaded and shipped) utilizing 5 actors this morning. The previous planned schedule may have been to fulfill the company A customer order first because there is sufficient inventory in the warehouse for that customer order, while the company B customer order requires some inventory be unloaded from one of several incoming shipments sitting in the warehouse trailer yard. Unfortunately, although 5 actors may have been scheduled to arrive today to fulfill these two customer orders, only 3 actors showed up this morning. Given this lack of labor resources, one of the customer orders may need to be delayed. However, there may be a significant penalty for delaying a customer order shipment for company B (i.e., the company B customer order has a much higher priority), so that customer order optimally needs to be scheduled for fulfillment prior to the company A customer order. In addition, of the incoming shipments parked in the yard with needed inventory for the company B customer order, one of those shipments may be close to being past due to the time spent waiting in the warehouse yard for unloading, which may cause a second significant penalty. Upon schedule planning module 220 being invoked or otherwise executed after only 3 actors arrive for work, the planned schedule may be updated automatically and dynamically to optimally allocate the available labor resources to pull in and unload the nearly past due trailer and then concurrently pick, repackage, load and ship the company B customer order and then subsequently pick, repackage, load and ship the company A customer order. This optimization may utilize a variety of factors including reducing travel (i.e., travel time, travel distance, reduce deadhead time, or a combination of these or other travel measurements) by the set of actors maximizing customer order fulfillment. Upon the modification of the planned schedule, schedule execution module 270 may then schedule and direct the updated planned schedule on a task by task basis into the WMS as the workload shifts in between planning cycles. As may be appreciated by one of ordinary skill in the art, much more complex scenarios involving more incoming shipments, more customer orders, more actors, etc. may be managed utilizing the embodiments or alternatives thereto as described herein.

In the present embodiment, schedule planning module 220 may frequently generate a planned schedule of distribution warehouse operations, such as about every 30 minutes, while projecting the planned schedule several days in advance or more. One reason for planning ahead for several days in advance is because some decisions made today may affect whether a shipment tomorrow may be delayed or on time. Even so, by running the schedule planning module every 30 minutes or so allows that module to dynamically adapt to current changes such as new orders, delayed incoming shipments, down equipment, missing actors, etc. This planned schedule generation frequency and projection time may be manually adjusted or modified for each implementation such as by a user of the scheduling system. This frequency and projection time may also be automatically adjusted based on various predetermined criteria such as whether the distribution warehouse is near throughput full capacity. Schedule execution module 270 may continuously or frequently, such as every minute or every few seconds, dynamically and automatically provide a detailed execution schedule of distribution warehouse operations as tasks in accordance with the latest higher level planned schedule generated by schedule planning module 220. Although scheduling system 200 is depicted including both schedule planning module 220 and schedule execution module 270, alternative embodiments may include just one of these modules or portions thereof in combination with other modules or components which may be preexisting in a distribution warehouse.

Database 210 may be utilized to store various types of data for utilization by schedule planning module 220 and schedule execution module 270 as well as other elements and entities as needed. Database 210 may be a single database or multiple databases and may be located on-site, remotely and/or in a cloud system. Database 210 may include appropriate controls to manage access to any data stored therein. Database 210 may include dynamic data 212 which includes data that may vary frequently such as production shipments 212a, incoming supplier shipments 212b, current inventory 212c and customer orders 212d. Such dynamic data may be generated in part by the various modules described herein. Many other types of dynamic data may be stored for utilization by the various modules as described herein such as planned schedules. Database 210 may also include constraints and capacities 214 which includes space constraints 214a, site constraints 214b, actor and action constraints 214c and types of tasks 214d which may be created for performance by actors and automated machines, as well as other types of data which may generally be more static. Such constraints and capacities may be identified by a constraint and capacity module such as described below. Other types of data may be stored in database 210, either in dynamic data 212, constraints and capacities 214 or in other databases or files 216 within of in conjunction with database 210. Other data 216 may include historical data 217 of many of the processes and results which may be utilized for statistical analysis for identifying problem areas or areas for improvement, for identifying needed modifications to various rewards and penalties as utilized by the optimizer and other modules, as well as for training learning systems such as artificial intelligence engines, meta-learning systems, etc. as may be described herein. Other data 216 may also include rewards and penalties 218 which may be utilized for prioritizing shipments, optimizing scheduling of those shipments, and other balancing considerations such as described herein. Other data 216 may further include other ongoing data which may be useful by the various modules and processes described herein, such as the number or length of time increments utilized for optimizing a schedule. As may be appreciated by one of ordinary skill in the art, other embodiments may utilize alternative ways to distribute and organize data as needed for utilization by the modules and other systems.

Schedule planning module 220 may include a constraint and capacity planning module 230, a task creation module 240, a sequence actor/assignment module 250, spatial assignment module 260 and a management module 265. Additional or different modules may be implement in alternative embodiments. For example, spatial assignment module 260 or an equivalent thereto may be implemented in schedule execution module 270.

Constraint and capacity planning module 230 may include several modules for generating the various constraints and capacities for storage in constraints and capacities 214. These constraints and capacities may be initially identified and stored upon implementation of task schedule planning module 220 and then only updated as needed such as upon distribution warehouse modifications. Constraint and capacity planning module 230 may include a space constraint and capacity module 232, a site constraint and capacity module 234, a labor and equipment constraint and capacity module 236 and a task time and sequence constraint and capacity module 238 for generating and storing certain constraints and capacities, respectively, in space 214a, site 214b, labor 214c and tasks 214d of database 210. Additional or different constraint and capacity modules may be implemented in alternative embodiments. Space constraint and capacity module 232 may include a list of bottlenecks and staging areas within the distribution warehouse site or campus. This may include warehouse yard area size and limitations for parking incoming and outgoing trailers or other goods container, the number of bays for loading and unloading trailers including capacities, staging areas for unloading trailers, gathering and repackaging picked goods, loading trailers, etc. Site constraint and capacity module 234 may include custom capacities and limitations such as whether a given customer's shipments may be only shipped from a specific bay, how a given customer's shipments must be sorted and loaded per that customer's specifications, etc. Labor and equipment constraints and capacity module 236 may include the capacities and constraints of actors generally, specific actors, certain automated machines and robots, equipment which may be utilized by the actors including qualifications to operate that equipment, etc. Task time and sequence constraint module 238 may include a large lists of tasks, the amount of time needed to complete those tasks, any sequencing of such tasks (i.e. pick inventory for a pallet prior to dropping that pallet off at a given staging area), etc. Other types of capacities and constraints may be identified and stored in memory as desired.

Task creation module 240 may take the incoming shipments of goods, any transfers of goods between warehouses, customer orders of goods, inventory levels, and associated locality information to generate the tasks needed to handle unloading, storing, picking, repackaging and shipping these goods for some period of time in the future, such as a few days. This period of time may be variable depending on conditions or other criteria such as the number of incoming or outgoing shipments. The generated tasks may include associated cost information for optimizations as described below. The generated tasks may be selected from a set of predetermined tasks 214d. Each task may be associated with and accumulated for a given shipment, transfer or customer order as well as a good or set of goods within that shipment, transfer or customer order. These generated tasks may include alternative sets of tasks to handle incoming or outgoing shipments. For example, different equipment and associated actor types may be utilized to unload and move goods of an incoming shipment to inventory. In the present embodiment, task creation module does not make any optimization decisions. Rather, it generates a large set of tasks including associated time, labor (i.e., actor types), equipment and space resources for handling incoming and outgoing shipments, including alternative sets of tasks, for subsequent decision making and optimization. These generated tasks may then be utilized as the building blocks for the following modules as described below.

Sequence actor assignments module 250, also referred to herein as optimizer 250, may take this generated set of tasks and its' associated information, including costs, and optimally assigns those tasks to actors (i.e., employees, contractors or other workers), machines (i.e., robots or other automated equipment which can automatically perform tasks in response to provided signals) or other labor resources, as well as to equipment needed to perform those tasks. These assignments may take into account which actors are qualified on which equipment, efficiency of the labor resources, capacity of the equipment, etc. These assignments can be accumulated for each incoming shipment, transfer and customer order to determine an approximate amount of time needed to handle each of them. Sequence actor assignments module 250 also optimizes a schedule, in sequence, of the various incoming shipments, transfers, and outgoing customer orders. In this optimization, module 250 may take into account a start date, a due date or other customer order priority, and the determined time needed to accomplish each incoming shipment, transfer, and outgoing order, any penalties for late handling, any rewards for on-time handling and order fulfillment performance indicators, capacities of labor resources, equipment and the distribution warehouse site, etc. Upon completion, this optimized schedule is stored in database 210 and/or passed directly to spatial assignment module 260.

In the present embodiment, spatial assignment module 260 may take the scheduled set of assigned tasks and may optimize the scheduled tasks based on space, site and other spatial constraints and capacities. This may include door assignments for incoming and outgoing trailers, identifying and assigning doors and staging areas for moving, accumulating and disseminating goods, etc. This may take into account general distances between the various site spaces. In an alternative embodiment, this module may be included in schedule execution module 270.

The operation of modules 230, 240, 250 and 260 may be managed by management module 265. That is, management module may coordinate the activities of these modules, such as the length of time they schedule forward, as well as manage their inputs and outputs. For example, as coordinated by management module 265, module 230 may be utilized on demand of a user to indicate changes to certain constraints and capacities or it may be utilized upon execution module 270 identifying certain new constraints and capacity changes when implementing a planned schedule. In an alternative embodiment, management module 265 may include one or more learning systems such as artificial intelligence (AI) engines to manage the inputs and/or outputs of the various modules. Such techniques may be referred to as meta-learning systems. For example, an artificial intelligence engine may be trained over time to adjust incoming shipment inputs to task generation module 240 based on prior experience of shipments based on time of year, supplier, etc. Management module 265 may also utilize the results of schedule execution module 270 to adjust expected task completion timing and other factors utilized by task creation module 240 or the other modules. Management module 265 may also provide additional management functions towards implementing new features and capabilities of the other modules.

Upon completion of modules 230, 240, 250 and 260 of the schedule planning module 220, including any management of those modules by management module 265, the results of the optimized schedules described above may be stored in database 210 as dynamic data 212 for use as described below by the schedule execution module 270. Alternatively, this information may be passed directly to module 270, such as by management module 265, for immediate utilization as described below. As described herein, the planned schedule may include a scheduled set of customer orders to be fulfilled including the tasks necessary to fulfill those customer orders.

In the present embodiment, module 270 may include a mission creation and awareness module 280, a work queue tasking module 290, a work management system (also referred to herein as a WMS) 295 and a management module 297. As described above site space assignment and planning module may be included in schedule execution module 270. Additional or different modules may be implement in alternative embodiments. In addition, WMS 295 may be a preexisting third party software system previously implemented at a distribution warehouse before integration of the present embodiment with that WMS. Although mission creation and awareness module 280, work queue tasking module 290 as well as management module 297 are shown as separate from work management system (WMS) 295, modules 280, 290 and/or 297 may be embedded in WMS 295 for tighter coupling resulting in a more integrated schedule execution module 270. Other alternative embodiments may be appreciated by one of ordinary skill in the art.

Mission creation and awareness module 280 schedules and assigns or otherwise allocates tasks to labor resources (e.g., actors and automated machines) based on the planned schedule generated by schedule planning module 220 so that the planned tasks may be performed in a timely and efficient manner. These task assignments may take into account labor resource efficiency, qualifications of each labor resource, spatial locations where each task should be performed (e.g., inventory location, trailer location, staging location, etc.) including labor resource location at the beginning and end of each task, etc. This is a type of optimization similar to a multiple traveling salesman problem including a variety of constraints as described herein which may affect the resulting solution.

Upon completion of the scheduling of task assignments to labor and equipment resources, a set of work queues for the labor and equipment resources may be generated. These work queues of allocated tasks may then be provided to the work queue tasking module 290 for utilization to direct the actions of work management system 295. Work management system 295 may then direct the work of each of the labor resources including managing any inputs and outputs from various devices such as hand scanners, laser guides, etc. Work management system 295 may include a look-up table (LUT) 296 for maintaining a list of assignable tasks, start and end times for those assignable tasks, and priorities for accomplishing each such assignable task.

The operation of modules 280, 290 and 295 may be managed by management module 297. That is, management module may coordinate the activities of modules 280 and 290 with WMS 295, such as the length of time they schedule forward, as well as manage their inputs and outputs. For example, as coordinated by management module 297, schedule execution module 270 may be utilized on demand of a user to modify certain planned tasks when implementing a planned schedule. In an alternative embodiment, management module 297 may include one or more learning systems such as artificial intelligence engines to manage the inputs and/or outputs of the various modules. For example, an artificial intelligence engine may be trained over time to adjust certain planned tasks by schedule planning module based on prior experience of shipments based on time of year, supplier, etc. Management module 297 may also utilize prior results of schedule execution module 270 to adjust expected task completion timing and other factors utilized by task creation module or the other modules. Management module 297 may also provide additional management functions towards implementing new features and capabilities of the other modules. In an alternative embodiment, management modules 265 and 297 may be combined into a single management module.

As may be appreciated by one of ordinary skill in the art, many alternative embodiments may be implemented without departing from the scope and spirit of the described embodiments. For example, work management system 295 may be a preexisting software implementation that has already been configured to work with the equipment and interfaces throughout the warehouse site or campus before introduction of the present embodiment.

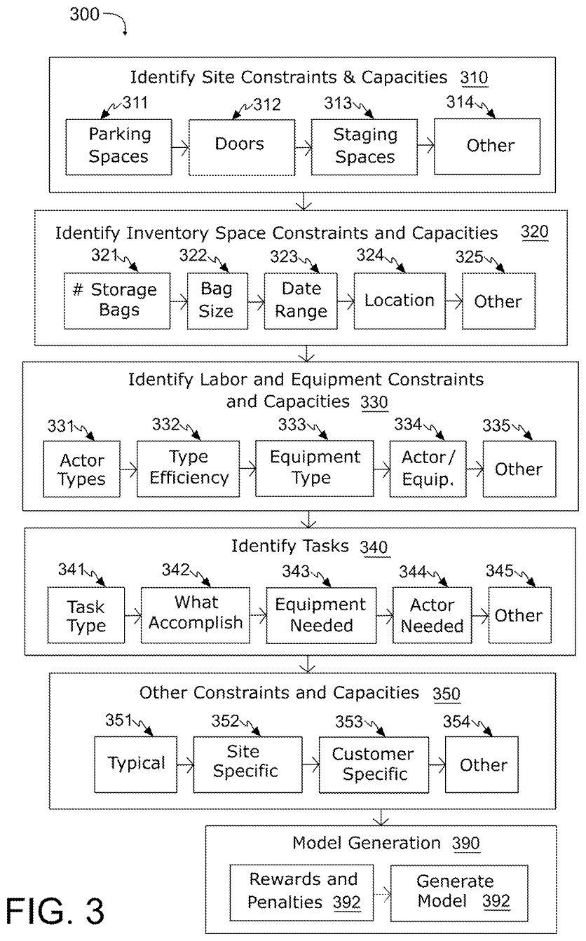

FIGS. 3, 4, 5 and 6 depict functions of the various modules of schedule planning module 220 towards optimizing a planned schedule of the operations of a distribution warehouse to handle incoming and outgoing shipments including reallocations and transfers, in which various embodiments of the present disclosure may be implemented. While constraints and capacities module may be utilized on an as needed basis, perhaps infrequently, task creation module 240, sequence actor assignment module 250 and spatial assignment module may be utilized on an hourly or other periodic or as needed basis to update and optimize this planned schedule to adapt to ongoing changes in conditions. In alternative embodiments, the timing of executing the various modules of schedule planning module 220 may be provided by a learning system or artificial intelligence engine. The planned schedule may extend for a reasonable time into the future such as for 24 to 48 hours, referred to herein as a planned schedule time period. This planned schedule is then passed onto execution module 270 for implementation as described below.

FIG. 3 depicts a flow diagram 300 of constraint and capacity planning module 230 identifying various constraints and capacities of a distribution warehouse site in which various embodiments of the present disclosure may be implemented. This identification process may be implemented when initiating schedule planning module 220 and when there are subsequent modifications to any of the constraints and capacities identified therein. That is, most of the elements identified pursuant to this flow diagram are generally static in nature and may only be occasionally modified. When such a modification occurs, only the relevant portions of this identification process may be utilized to implement the modification. In an alternative embodiment, constraints and capacities module may be run periodically to verify whether modifications or other updates are needed. The constraints and capacities identified in this process may be converted into equations or other representations suitable for use by an integer based linear equation or other site-wide model that may be utilized by other modules such as in schedule planning module 220 and/or schedule execution module 270. The description of FIG. 3 may reference elements of other Figures described herein.

Flow diagram 300 may include major identification steps including identifying site constraints and capacities 310, identifying inventory space constraints and capacities 320, identifying labor and equipment constraints and capacities 330, identifying tasks 340, identifying other constraints and capacities 350 and converting identified constraints and capacities into a site-wide model 390 suitable for use by schedule planning module 220 or schedule execution module 270. Additional major steps may be included depending on the site being modeled.

Identifying site constraints and capacities 310 may include identifying various general physical features of the site being modeled, particularly those physical features that may affect any modelled operations of the site. For example, there are various physical features of a site that may affect the loading and unloading of trailers or other shipping containers. This may include identifying parking spaces 311, doors 312, staging spaces 313 and other constraints and capacities 314 (e.g., storage space inside the distribution warehouse). Parking space identification 311 may include parking spaces suitable for holding containers or other transportation units that may have been dropped off or may be utilized by a driver while awaiting an open door for unloading and/or loading or a parking space for dropping off a trailer. This modeling may include the number of parking spaces by type of parking space as well as any other restrictions such as parking spaces dedicated to a particular customer or type of container (e.g., refrigerated). Door identification 312 may include doors to the warehouse for loading and/or unloading containers or other transportation units. Door identification 312 may include a number of unloading/loading doors, an approximate location of the doors relative to various features such as inventory storage or refrigeration storage. Door identification 312 may include other restrictions such as whether they may be limited to certain customers or product type (e.g., caustic or other unusual items requiring special handling and/or storage). Staging space identification 313 may include areas within or even outside the distribution warehouse for staging a load of items for loading a shipping container or for holding unloaded items from a shipping container until such items can be moved to inventory bays or other loads. Staging space identification 313 may also be associated with a given door or set of doors. That is, a staging area may be located near and associated with a specific door for storing picked items prior to loading those items in a desired door. This may allow for ordering the picking of items for a load tin a different order than those items may be loaded in a trailer, thereby allowing greater efficiencies in picking. However, staging areas also allow an item to be handled multiple times (drop off and pick up) creating additional inefficiencies that may need to be accounted for as described herein. Generally in practice, the number of staging spaces may be a greater constraint on receiving and shipping inventory than the number of doors. For example, it may take only 30 to 40 minutes to load an outgoing trailer from a storage space or unload an incoming trailer to a storage space. However, it may take several hours for pickers to pick items for an outgoing trailer load from bins to a given storage space and it may take several hours to put away unloaded incoming inventory from a given storage space to the proper bins for that inventory. Some distribution warehouses may not utilize staging spaces and may load pallets directly from storage into a trailer through different processes, which could be reflected in the lack of staging spaces as well as different task types. Identifying other site constraints and capacities 314 may include any other general site bottlenecks such a certain narrow hallways or low ceilings that may affect the unloading, storing, picking and loading of items into trailers or other shipping containers. In addition, shipments to certain customers may be limited to certain staging areas and associated doors due to extra processes required by those customers. For example, if a given customer requires additional specialized wrapping or labeling on each pallet shipped to that customer, the equipment for performing that additional specialized wrapping or labeling may be located at or near a limited number of staging areas and associated doors.

Identifying inventory space constraints and capacities 320 may include identifying storage bays 321, bay size 322, date range 323, locations 324 and other inventory space factors 325. Identification of each item storage bay 321 may be accomplished individually or as sets of inventory bays. For example, all bays for a given distribution warehouse or subset thereof may have a standard size. Bay size identification 322 may include the volume and other dimensions of each bay or set of bays such a width, depth and height. These dimensions may be in standard measurements such a metric or may be in number of standard size pallets. Date range 323 may include inventory range requirements for certain storage bays, for certain item types, etc. This helps prevent the mixing of aged inventory with new inventory, thereby allowing the picking of inventory according to age as preferred or required by a given customer or governmental regulations. Identification of storage bay location 324 may be in GPS (global positioning system) coordinates, in X, Y and possibly Z coordinates, or other coordinate system for use as described herein. For example, where there may be shelving such that one storage bay may be located above another bay, a Z coordinate may be utilized. Identifying other inventory space and constraints 325 may include identifying item type requirements (e.g., storage bays located in a refrigerated portion of the distribution warehouse), customer restrictions and requirements such a certain storage bays dedicated for certain customers, etc. Further inventory space constraints and capacities may be identified based on the particular distribution warehouse.

Identifying labor and equipment constraints and capacities 330 may include identifying actor types 331, identifying actor type efficiency 322, identifying equipment type 333, identifying actor type/equipment type constraints 334, and other labor and equipment constraints and capacities 335. Identifying actor types 331 may include types of persons working in the distribution warehouse that may unload, store, pick and load items as needed as well as any other functions that may be needed such a disposing of overaged inventory or moving dropped off transportation units from parking spaces to loading doors. For example, some actors may be trainees limited to certain functions, regular workers that may work across all functions, contractors that may limited to certain functions or not, etc. Identifying actor type efficiency 332 may include a percentage function. For example, a trainee may be only 50 percent as efficient as a regular worker for a given function. Identifying equipment type 333 may include identifying equipment utilized throughout the distribution warehouse for the various functions described herein. For example, all forklifts may be identified including certain capabilities and restrictions that may be applicable. That is, some forklifts may carry multiple pallets concurrently and each forklift may have certain weight restrictions. Identification of actor/equipment constraints and capacities 334 may include any certification or other training needed prior to an actor or actor type may utilize that equipment for certain functions. For example, a trainee may need certain training before utilizing a multi-pallet forklift for picking items. Identifying other labor and equipment constraints and capacities 335 may include many other types of constraints and capacities such as whether certain workers are limited to certain parts of the distribution warehouse, whether certain equipment has a predictive amount of up time between schedule maintenance events, etc.

Identification of tasks 340 may include identifying a universe of tasks which may be performed by actors and equipment to accomplish the needed unloading, storing, picking, loading and other functions site-wide. Identifying tasks 340 may include identifying task types 341, identifying what is accomplished 342 by each task type, identifying the equipment needed 343 to perform each task type, identifying the actor type 344 needed to perform each task type, and other resources or other requirements needed 345 to perform each task type. Task identification 340 may include a large variety of tasks needed to perform certain functions or sub-functions within the distribution warehouse. For example, a task may include utilizing a forklift to move a pallet from a transportation unit at a door to a staging area. Such a task may include the equipment needed, the actor type needed, etc. There may also be alternatives such as whether a single pallet forklift may be utilized for moving a pallet or a dual pallet forklift may be utilized for moving two pallets concurrently. While the dual pallet forklift unloading task may be more efficient, it may also require a certain trained actor type to utilize that forklift. Task types may be quite broad or very granular, depending on the circumstances, limitations and capabilities of a distribution warehouse operation. For each task type, identifying what is accomplished 342 by that task type is associated with that task type. Driving a forklift to an identified bay for picking an item may be identifying as the function accomplished for a given task. Identifying the equipment needed 343 and actor needed 344 for a given task type may be performed to make sure the appropriate equipment and actor type is allocated for accomplishing and scheduling the task type. Other types of resources needed to accomplish a given task type 345, such as space resources, may be identified for allocating and scheduling those resources as needed.

Other data 216 may include historical data 217 of many of the processes and results which may be utilized for statistical analysis for identifying problem areas or areas for improvement, for identifying needed modifications to various rewards and penalties as utilized by the optimizer and other modules, as well as for training learning systems such as artificial intelligence engines, meta-learning systems, etc. as may be described herein. Other data 216 may also include rewards and penalties 218 which may be utilized for prioritizing shipments, optimizing scheduling of those shipments, and other balancing considerations such as described herein. Other data 216 may further include other ongoing data which may be useful by the various modules and processes described herein.

In step 390, the various constraints, capacities and tasks described herein may be modeled for use as described herein. In a first step 391, various rewards and penalties may be identified and generated (or later modified) for prioritizing shipments, optimizing scheduling of those shipments, and other balancing considerations such as described herein. For example, there may be penalties for unloading incoming shipments late, loading outgoing shipments late, running out of inventory, letting inventory spoil, maintaining too large of inventory levels, loading and storing an outgoing shipment too early, etc. as well as rewards for unloading incoming shipments with needed items for inventory somewhat early, loading outgoing shipments to customers on time or somewhat early, etc. Penalties and rewards may be monetarily based to estimate the actual costs and rewards of the distribution warehouse activities. Some penalties and rewards may be somewhat artificial so as to encourage or discourage certain desired or undesired activities. For example, penalties for early performance, such as loading and storing, are generally large enough to discourage using those resources before other higher priority shipments are processed, yet small enough to allow the utilization of available resources when they are available. In step 392, all such constraints and capacities as well as rewards and penalties may be described mathematically as part of a mixed integer linear programming model. In addition, certain additional constraints may be built into the model to prevent the model from implementing physically impossible or impractical events such as preventing negative inventory, requiring that empty trailers are needed before loading, etc. In the present embodiment, the distribution warehouse constraints and capacities may be modeled en masse initially, then modified based on new or changed constraints and capacities as they are provided or otherwise input. In an alternative embodiment, all such constraints and capacities may be utilized as part of a training model for an artificial intelligence or other learning system. Although shown as a separate step at the end of steps 310-340, step 390 may be performed concurrently with the above described steps. In addition, any modifications to the various constraints, capacities or tasks may be modeled concurrently with such modifications. In another alternative embodiment, such a model may be generated and maintained in a separate module from constraints and capacities module 230.

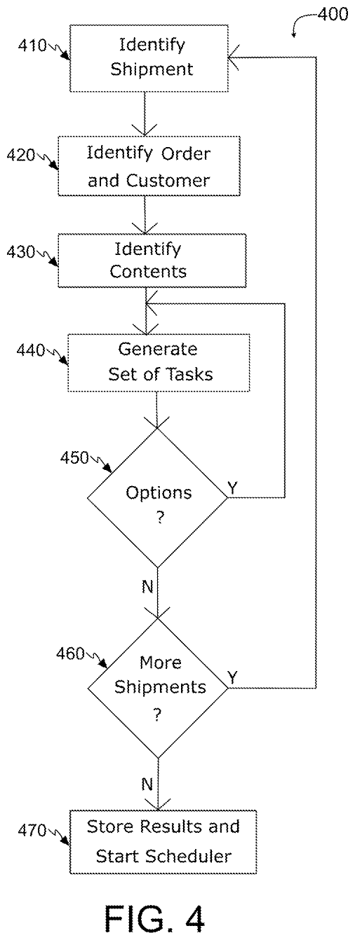

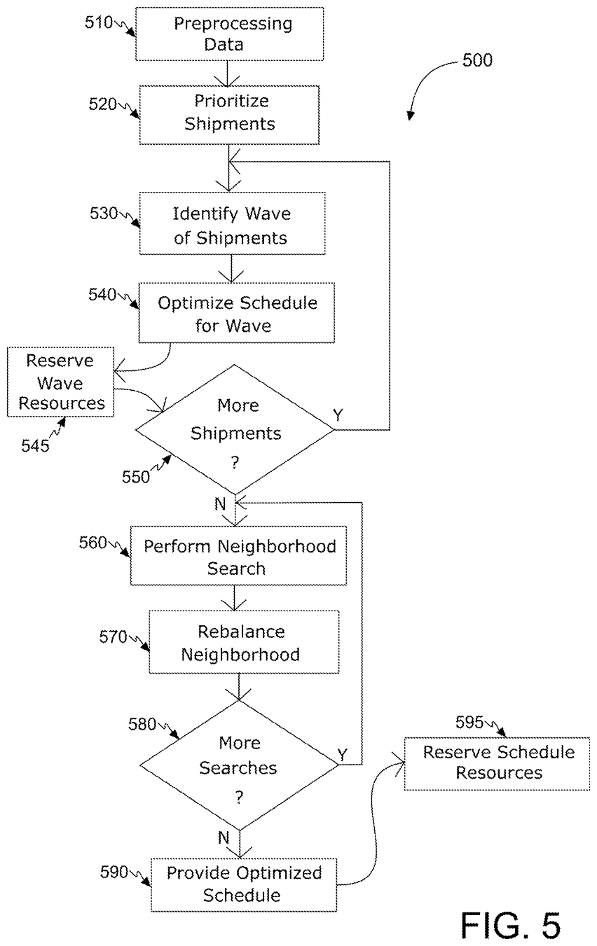

FIG. 4 depicts a flow diagram 400 of task creation module 240 generating a set of tasks to handle and fulfill incoming and outgoing shipments of a distribution warehouse site, in which various embodiments of the present disclosure may be implemented. That is, task creation module may identify and generate a set of tasks that should handle incoming shipments and transfers including unloading and storing goods in inventory as well as fulfill outgoing shipments including picking ordered items from inventory and loading those items into outgoing shipments. This may include tasks for moving the transportation units to and from local parking spaces, gathering and organizing items in staging areas, handling certain required tasks such as clearing outdated inventory and standard equipment maintenance, etc. Such task creation may be configured differently for different distribution warehouse sites as desired. In the present embodiment, task creation module 240 may perform the processes described with reference to FIG. 4 every hour or similar time period. Alternatively, task creation module 240 may perform the processes described with reference to FIG. 4 as new shipments are added, whether incoming or outgoing including transfer and reallocation shipments. Sequence actor assignment module 250 and spatial assignment module 260 may subsequently perform the processes described with reference to FIGS. 5, 6 and 7 prior to passing a planned schedule to schedule execution module 270. Other possible times for task creation module 240, as well as sequence actor assignment module 250 and spatial assignment module 260, to perform these processes may be known to one of ordinary skill in the art. The description of FIG. 4 may reference elements of other Figures described herein.

Task creation module flow diagram 400 may start with identifying or otherwise acquiring information regarding an incoming or outgoing shipment 410 including a unique shipment identifier (ID). An incoming shipment, often referred to as a receipt, may be identified from internal databases such as database 120, by a query to an applicable WMS or other commercial software such as SAP, or other methods and sources as may apply in a given distribution warehouse management system. Such an incoming shipment of potential inventory may come from a variety of providers including third party suppliers, third party or internal producers, etc. In addition, transfers from other distribution warehouses may be considered as an incoming shipment. Furthermore, incoming shipments may include shipments originally slated to another distribution warehouse but which have been redirected to the current distribution warehouse by shuttle management module 160. An outgoing shipment may also be identified from internal databases such as database 120, by a query to an applicable WMS other commercial software such as SAP, or other methods and sources as may apply in a given distribution warehouse management system. In addition, planned transfers of goods to other distribution warehouses may be considered as an outgoing shipment. In an alternative embodiment, outgoing shipments may also be identified as individual parcels not necessarily identified at the trailer level such that a customer order may be identified as an outgoing shipment. Identifying such shipments, whether trailer based or customer order based, includes identifying the expected timing of those incoming and/or outgoing shipments. Then in step 420, all orders included in the shipment are identified or otherwise acquired with their order ID as well as each incoming order provider ID or outgoing order customer ID. If the shipment is a transfer from or to another distribution warehouse, the shipment may be considered a single order with an ID of that distribution warehouse. Furthermore, in step 430, the contents of the incoming or outgoing shipment may be identified or otherwise acquired. This includes identifying the items and quantity of those items in that shipment. The quantities for each item, across all shipments, may be described in the smallest packing amount to foster simpler optimization across multiple shipments of the same item. That is, some items may be picked or ordered in pallets, cases, or pieces, whichever is the smallest amount of items that may be handled singularly by a picker, shipped singularly by a provider, or ordered singularly by a customer. Additional information may also be identified or otherwise acquired any additional steps as needed such as expected maintenance of equipment. Steps 410-430 may be performed concurrently or sequentially depending on how such information may be accessed through internal databases or other sources. Steps 410-430 may also be performed in a single inquiry to internal databases 210 or in a single call to WMS 295.

In step 440, task creation module 240 may generate a set of tasks and associated time, labor (i.e., actor types), equipment and space resources needed to handle each identified order of the identified shipment. This set of tasks may be few in number for a given shipment and estimated generally based on prior experience such as may be derived from historical data and/or from the prior estimations of an experienced worker. This set of tasks may be at a high level, but geared towards the types of tasks utilized by a downstream work management system. As a result, this set of tasks may be highly configurable for application in a multitude of distribution warehouse environments. In the case of an incoming shipment, this may include the tasks, time, labor, equipment and space resources needed to move the incoming shipment trailer from a parking lot to a warehouse door, unload each order from the trailer to a staging space, move those ordered items from the staging space into inventory, and then move the trailer away from the warehouse door to a parking area. In the case of an outgoing shipment, this may include the tasks, time, labor, equipment and space resources needed to pick ordered items from inventory, place those picked items (typically packed into pallets) in a staging space, move the trailer from a parking area to a warehouse door for loading, load those items from the staging space onto the parked trailer, and then move the loaded trailer from the warehouse door for shipping. This set of tasks and associated time, labor, equipment and space resources may be associated with the identified incoming or outgoing shipments and orders without any scheduling of those tasks. That is, task creation module 240 may generate the tasks, time, labor, equipment and space resources needed to for this incoming or outgoing shipment without addressing the current availability of the labor, equipment or space resources to accomplish these tasks so long as those labor, equipment or space resources exist as per internal databases 210, which may be addressed in optimizer 250 as described below. This set of tasks and associated time, labor, equipment and space resources may take into account the customer or provider ID, the type of items included (e.g. associated weight or volume), or other related information for a given order. For example, pallets of especially heavy ordered items may need to be unloaded or loaded singly and not in pairs, unlike pallets of lighter ordered items. Also, certain customers may require special handling and packaging of their orders, requiring different equipment or time to complete handling of their orders. Other factors may be identified and utilized for determining the tasks, time, labor, equipment and space resources needed to complete those tasks. Buffers may be included in the resources needed for accomplishing each task, particularly time buffers, to allow for variability in accomplishing each task, such as variability in travel distance, worker efficiency, etc. Management module 265 and its learning systems or artificial intelligence (AI) engines may be utilized for better determining and predicting such tasks and associated timing, labor, equipment and space resources.

In step 450, it is determined whether there may be alternatives or other options for accomplishing the same results for this identified shipment and orders. That is, alternative sets of tasks and associated time, labor, equipment and space resources may be generated for some or all orders of a given shipment. These tasks, time, labor, equipment and space resources may be broken down by type of resource needed to accomplish each task. For example, the orders in a trailer or other transportation unit may be unloaded to a staging area through a set of tasks, time, actor type, equipment and space resources by a minimally trained contractor utilizing a single pallet forklift. Alternatively, the same orders of the same trailer may be unloaded to a staging area through a second set of tasks more quickly by a more highly trained full-time worker utilizing a multi-pallet forklift. In addition, unloading of the trailer may be to a staging area, directly to inventory or a combination thereof. If yes in step 450, then processing returns to step 440 for generating the alternative set of tasks and associated time, otherwise processing continues to step 460

In step 460, it is determined whether there are additional incoming or outgoing shipments for order task and time generation, or other sets of tasks needed such as scheduled maintenance. This may include all incoming and outgoing shipments expected for a given period of time or other measure. If yes, then processing may return to step 410 for generating tasks and associated time for another shipment. If not, then processing continues to step 470. In step 470, the results of this task and time generation may be stored in databases 110 and the sequence actor assignment module 250 may be invoked for optimizing scheduling of the shipments including the associated tasks, timing, labor, equipment and space resources needed as described herein.

FIG. 5 depicts a flow diagram 500 of the sequence actor assignment module 250 optimizing a schedule of the generated set of tasks to handle and fulfill incoming and outgoing shipments of a distribution warehouse site, in which various embodiments of the present disclosure may be implemented. That is, in the present embodiment, optimizer 250 takes sets of tasks organized by shipments and optimizes scheduling of those sets of tasks at a time when there are labor, equipment and space resources available to accomplish those sets of tasks within the various constraints and capacities of the distribution warehouse, including inventory. This optimal scheduling may also takes into account the various alternatives for each shipment set of tasks and determines a preferred alternative (e.g., an actor type and equipment combination) as part of this scheduling. The description of FIG. 5 may reference elements of other Figures described herein.

In the present embodiment, the schedule may be configured as hourly for 36 hours as the planned schedule time period. The number of time increments may be increased or decreased, thereby geometrically increasing or decreasing the time needed to optimize the schedule. In an alternative embodiment, the schedule may be configured in shorter time increments, such as every half hour, for the first few hours and then configured for longer time increments, such as hourly and/or bihourly thereafter. This alternative embodiment may be driven by more data certainty in the near term, less data certainty in the longer term, and the effect of the number of time intervals and shipments on optimizing scheduling. The number of time increments may also be configured for a greater or shorter length of time, such as for 24 or 48 hours. Such variations in time configurations may be manually set forth in other data 216 as described herein, or may be automatically set forth by statistical or machine learning system results of analyzing historical data. In the present embodiment, sequence actor assignment module 250 may perform the processes described with reference to FIG. 5 on an hourly or other periodic or as needed basis to update and optimize this planned schedule to adapt to ongoing changes in conditions Alternatively, sequence actor assignment module 250 may perform the processes described with reference to FIG. 5 upon a threshold of changes to ongoing conditions, such as upon changes in labor, equipment, customer orders and other changes which may affect the schedule. Other possible times for optimizer 250 to perform these processes may be known to one of ordinary skill in the art.

In a first step 510, preprocessing may be performed of data needed for optimizing the scheduling of the generated set of tasks for incoming and outgoing shipments. This may include identifying the number and length of time increments for scheduling, identifying the current state of ongoing shipments, etc.

In step 520, the incoming and outgoing shipments are prioritized. This may include transfers of items from other distribution warehouses as well as reallocation of shipments previously headed to other distribution warehouse. This prioritization may be based on a variety of configurable factors. These factors may be weighted based on prior experience, statistical analysis and/or machine learning. These weights may be monetarily based, such as with penalties and rewards, in part or in whole. The same, a subset or different penalties and rewards may be utilized for prioritization in this step and optimized scheduling in step 540 below. That is, the penalties and rewards for prioritization may be more approximate and shipment status centric whereas the penalties and rewards for optimized scheduling may be much more granular and workload centric. For example, shipments currently being picked, loaded or unloaded may be given a high priority. Outgoing shipments may be given a higher weight priority than incoming shipments to meet customer demands, unless certain incoming shipments contain items needed for inventory to fulfill outgoing shipments. Outgoing shipments to certain customers may be given a higher weight priority due to late charges or other factors that may apply to those customers. Incoming drop shipments may be given a lower weight priority that live incoming shipments due to the lower cost and flexibility provided with drop shipments. Many such factors may be identified and utilized in determining a priority of the various shipments.

In step 530, a wave of higher priority shipments, incoming and outgoing, may identified. This wave may include a fixed number of high priority shipments as determined in step 520 above. This wave may also include a variable number of high priority shipments within a predetermined range based on clustering of the shipments by priority. This wave may also include all shipments if certain conditions are met. That is, if there is sufficient processing power to optimize scheduling of all shipments concurrently in a reasonable amount of time, then all such shipments may be included in a single wave. This may depend on the number of time periods utilized for scheduling, the number of shipments being schedule, the number of alternatives to consider for each shipment, etc. Historical data may be utilized by statistical analysis or learning systems such as artificial intelligence to identify and ideal number or clustering heuristics to utilize in generating a wave of shipments for use as described below.

In step 540, the schedule may be optimized for the wave of shipments identified in step 530 utilizing the fixed integer linear programming model generated as described herein. That is, optimizer 250 may be utilized for concurrently optimizing the schedule for each shipment of the wave identified in step 530, including the set of tasks and associated time, labor (i.e., actor types), equipment and space resources needed to handle the orders included in each shipment as well as any identified alternatives thereto. The model utilized for optimizing each wave of shipments may provide a lowest cost solution given the various rewards and penalties that may apply within the various constraints and capacities available (e.g., site constraints and capacities, inventory space constraints and capacities, labor and equipment constraints and capacities, etc.) as well as time, tasks and inventory availability. The scheduling of shipments in time may differ from their priority due to the various penalties and rewards applicable to the tasks for each shipment. For example, a higher priority shipment, based on customer, may not be due for a couple of days so scheduling that shipment a bit later may be justified so long as a sufficient buffer is provided so that the shipment to that customer not be late. In addition, as described below, each scheduled set if tasks for each shipment may include a time buffer to account for unexpected delays. Such a time buffer may be smaller for shipments scheduled in the near term versus shipments scheduled further in the future.

Once the wave of shipments are scheduled by optimizer 250, all associated time, labor, equipment and space resources may be reserved for use as scheduled in step 545. This may include, for each task of each scheduled shipment, a scheduled start time and a scheduled end time, man hours or other workload measure needed to perform the associated task, space resources needed such as whether a staging area is needed, as well as equipment needed to perform the associated task. Also included may be cuts to customer orders and cross-docks. Cuts to customer orders are where some ordered items may not be included due to inventory shortages. Cross-docks are where inventory being unloaded from an incoming shipment may be loaded onto another outgoing shipment concurrently. That is, the unloading and concurrent loading of the same items may need careful coordination by the downstream execution module. The scheduled start time and end time for each task may include a buffer based on whether the scheduled task may start earlier or later while still meeting the constraints and capacities of the linear programming model. As will be described below, this provides the execution module some flexibility in implementing the planned schedule, thereby allowing the execution module to make last minutes changes (e.g., such as between schedule planning optimizations) to tasks to adapt to real time conditions. Other resources, such as labor resources, may have a buffer built in such as to allow for variations in real time conditions. In the case of multiple waves of shipments being optimized, these buffers may be determined and fixed after each wave optimization, not determined until the last wave has been scheduled, or modifiable after each or after the final wave of shipment optimization. In an alternative embodiment, the scheduling start and end times, workload, equipment and spatial resources generated by this step may be expressed on a shipment by shipment basis rather than a task by task basis.

In step 550, it is determined whether there may be more prioritized shipments available for scheduling. That is, are there more shipments not already scheduled that may need scheduling? There may be additional customer ordered outgoing shipments and expected incoming shipments, but those shipments may be slated for far in the future such that it would not be worthwhile scheduling them at this time. In addition, the optimized schedule may be so full for the given number of time periods, or any remaining shipments for scheduling have due dates far in the future, so that scheduling additional shipments may be fruitless or not worth the processing power to continue generating waves of shipments for scheduling. If yes, there are more prioritized shipments for scheduling, then processing returns to step 530 for identifying another wave of shipments for scheduling. If not, then processing continues to step 560.

In step 560, a technique referred to as variable neighborhood search may be utilized for improving a multi-wave schedule. However, if only one wave of shipments was scheduled utilizing a fixed integer linear programming model, then the schedule is already optimized and may not need variable neighborhood search for more improved scheduling. In this step, the current schedule is analyzed for identifying a possible set of shipments and associated time periods for improved scheduling. For example, one set of shipments starting in one time period may be fulfilled ahead of time and another set of shipments in the next time period may be fulfilled late. In such a case, it may be likely that there may be room for improved scheduling. Such imbalances may be more likely at transitions between different waves of shipments. Various heuristic or other techniques for identifying such possible set of shipments and associated time periods for improved scheduling may be known to those of ordinary skill in the art. In addition, training learning systems such as artificial intelligence engines, meta-learning systems, etc. may be utilized for identifying such shipments and associated time periods for improved scheduling.

In step 570, once a possible set of shipments and associated time periods are identified in step 560, that portion of the schedule may be re-solved with the fixed integer linear programming module or other analytical tool known to those of ordinary skill in the art. That is, those identified shipments and associated time periods may be unscheduled and then scheduled with the optimizer as a new wave of shipments. Once re-solved, the overall summary of penalties and rewards for the resulting new schedule may be compared to the overall summary of penalties and rewards for the prior solved schedule. If there is an improvement, then the re-solved schedule may be stored as updated, otherwise the re-solved schedule may be discarded. If the re-solved schedule is utilized, it may include updated, for each task of each scheduled shipment, a scheduled start time and a scheduled end time, man hours or other workload measure needed to perform the associated task, space resources needed such as whether a staging area is needed, as well as equipment needed to perform the associated task. The scheduled start time and end time for each task may include a buffer based on whether the scheduled task may start earlier or later, as well as updated buffers to other resources, while still meeting the constraints and capacities of the linear programming model.

In step 580, it is determined whether it may be worthwhile performing additional variable neighborhood searches. For example, if the improvement of the prior neighborhood search was below a certain threshold, then it may be determined that it is not worthwhile pursuing additional variable neighborhood searches. For another example, once a predetermined number of neighborhood searches are performed, then the searching for additional improvements to the schedule may be discontinued. Other criteria for continuing or discontinuing such variable neighborhood searches may be utilized as known to those of ordinary skill in the art. If additional variable neighborhood searches are worthwhile, then processing may return to step 560, otherwise processing continues to step 590.

In step 590, the optimized schedule may be provided to a user for manual adjustments. For example, the user may be aware of an upcoming significant snow storm that will likely delay certain shipments. As a result, the user may either move certain outgoing shipments up in time to beat the storm or delay those shipments until the storm is expected to have passed. This step allows for the schedule to be modified by a user that has knowledge of events or circumstances that are outside the purview of the present embodiment. Alternatively, this step may be optional or not implemented in some embodiments.

In step 595, the resources scheduled by optimizer 250 are reserved as scheduled for implementation as scheduled. This includes the labor, equipment, space, inventory and other resources, including associated buffers, as well as any cuts to customer orders and cross-docks as described herein. The schedule and associated resource reservations are also saved to historical data 217 for future statistical analysis such as by learning systems or artificial intelligence systems.

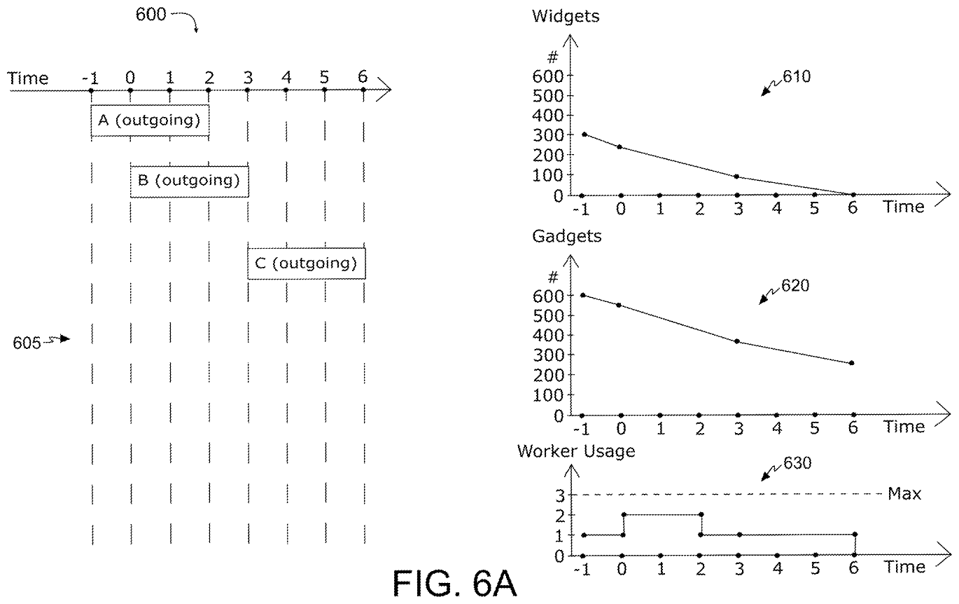

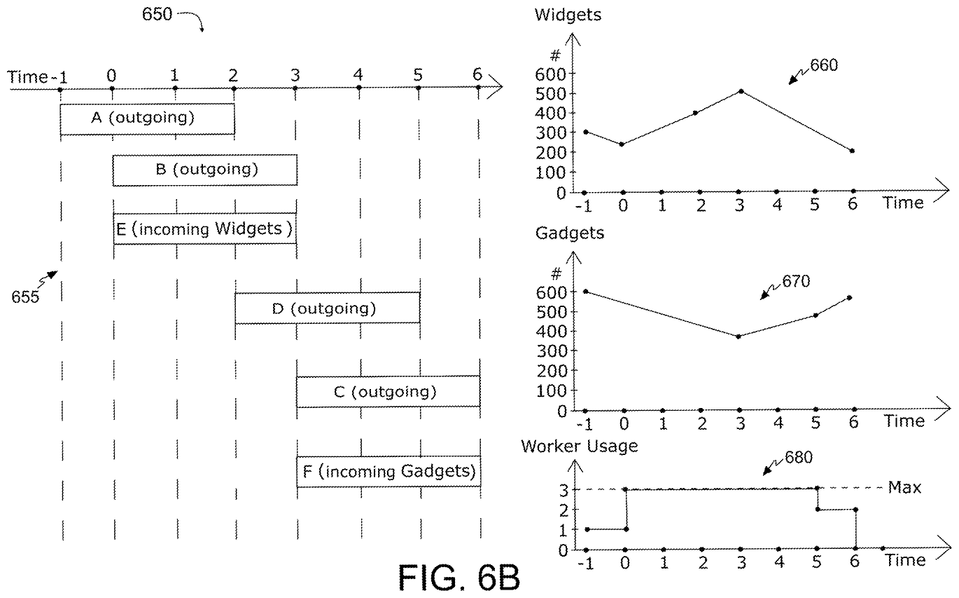

FIGS. 6A and 6B depict a diagram of a graphical user interface page providing a schedule optimization such as by optimizer 250, in which various embodiments of the present disclosure may be implemented. The description of FIGS. 6A and 6B may reference elements of other Figures described herein. FIGS. 6A and 6B are provided herein to depict the scheduling of each wave of shipments. FIG. 6A may not be provided to an end user or even generated in some embodiments as the end result of scheduling (i.e., FIG. 6B) may be the focus of many users.

FIGS. 6A and 6B provide a simplified example a schedule optimization of two waves of three shipments each to illustrate how such an optimization may function. In this example, there are six shipments including one ongoing shipment currently being loaded or unloaded, three upcoming outgoing shipments and two upcoming incoming shipments of two different items identified herein as widgets and gadgets. These six shipments may be prioritized as A through F based on whether they are ongoing, outgoing and incoming, in that order, as well as by shipment due time and customer importance, such as described above with reference to step 520 by optimizer 250. Shipment A may be an ongoing outgoing shipment to a customer (i.e., a shipment in process of being loaded). Shipments B, C and D may be outgoing shipments in the order of their due time and/or based on an importance of the customer receiving those orders (e.g., some customers may be higher priority based on penalties for late shipments or other factors). Shipments E and F may be incoming shipments in the order of importance of low inventory (i.e., a lower inventory item shipment may be given a higher priority). Ongoing and outgoing shipments A through D may include 100 widgets and 100 gadgets. Incoming Shipment E may include 300 widgets and Shipment F may include 300 gadgets. Each shipment may take three time periods (e.g., hours) to either dock, load or unload, and then undock in this example. For simplification, no buffers to the start and end times are included in this example. Each shipment is depicted as a single task in FIGS. 6A and 6B, although more detailed user interfaces may depict multiple tasks for each shipment such as docking, loading, unloading, etc. As may be appreciated by one or ordinary skill in the art, other examples may include more or fewer shipments, more or fewer shipments per wave, more or fewer waves of shipments, differing and variable time periods for handling a shipment, differing and variable number of tasks to perform for each shipment including alternatives for handling each shipment, different priorities for prioritizing and/or for scheduling shipments, etc., without departing from the scope of the present embodiments and alternatives thereto.

FIG. 6A depicts a diagram 600 of a graphical user interface page 605 providing a schedule optimization of a first wave (i.e., shipments A, B and C in this simplified example) such as described above with reference to steps 530 and 540 by optimizer 250. Shipment A is shown first as an ongoing shipment as of time 0 (i.e., the current or near-term time), having been started as of time −1 (i.e., shipment A started loading one hour prior to the current time) and completing at time 2. Outgoing shipment B is shown as starting as of time 0, as that shipment may be due soon and the penalty for a late shipment may be large given the customer of that shipment, and completing as of time 3. Outgoing shipment C is shown as starting as of time 3, as it may be due later that shipment B and the penalty for a late shipment may be less than the penalty for an early shipment at time 0, and completing as of time 6.

Graphical user interface elements 610, 620 and 630 depict inventory levels of widgets, gadgets and workload utilization, respectively. Other relevant factors such as equipment utilization could also be shown. Graphical user interface elements 610, 620 and 630 may be shown in a pop-up window or other graphical user interface. As shown in graphical user interface element 610, widget inventory levels are quite low with only enough widgets to fulfill the A, B and C shipments currently, ending in zero inventory at time period 6. While there is an incoming shipment D with widgets in the second wave, that shipment and wave are not yet considered by optimizer 250 in this example. In addition, as shown in graphical user interface element 620, there are sufficient gadgets in inventory to fulfill the currently scheduled outgoing shipments as well as several future outgoing shipments. For this simplified example, there may be only one worker type. In this example, there are three workers currently available with one worker needed for each shipment. As shown in graphical user interface element 630, there are sufficient workers available to handle the currently scheduled workload of the first wave.

FIG. 6B depicts a diagram 650 of a graphical user interface page 655 providing a schedule optimization of a second wave (i.e., shipments D, E and F in this simplified example) such as described above with reference to steps 530 and 540 by optimizer 250. Incoming shipment E with widgets is shown as the third shipment starting at time 0 and completing at time 3. This allows for sufficient widgets in inventory for loading future outgoing shipments. Outgoing shipment D is shown as the fourth shipment starting at time 2 and completing as of time 5, whereby outgoing shipment C is now shown as the fifth shipment starting at time 3 and completing as of time 6. Incoming shipment E with gadgets is shown as the sixth shipment starting at time 3 and completing as of time 6, concurrent with shipment C.

Graphical user interface elements 660, 670 and 680 depict inventory levels of widgets, gadgets and workload utilization, respectively. Other relevant factors such as equipment utilization could also be shown. Graphical user interface elements 660, 670 and 680 may be shown in a pop-up window or other graphical user interface. As shown in graphical user interface element 660, widget inventory had started to drop prior to time 0, then increases over time 0 to time 3 as incoming shipment E widgets is unloaded, despite loading widgets on outgoing shipments A, B and D. Widget inventory again drops from time 3 to time 6 as outgoing shipments D and C are loaded. Although widget inventory is relatively low, the scheduling if incoming shipments of widgets will help fulfill any expected outgoing shipments. As shown in graphical user interface element 670, gadget inventory levels drop from time −1 to time 3 as shipments A, B and D are loading. Gadget inventory levels then rise from time 3 to time 6 as shipment F with gadgets is unloaded, despite loading gadgets onto outgoing shipments D and F. As described above, for this simplified example, there may be only one worker type. In this example, there are three workers currently available with one worker needed for each shipment. As shown in graphical user interface element 630, there are sufficient workers available to handle the currently scheduled workload of both the first and second wave, although they are at maximum utilizations from time 0 to time 5. As a result, additional shipments may not be scheduled during this time of maximum utilization of worker resources.

As may be appreciated by one of ordinary skill in the art, had shipment C been scheduled for time 0 to time 3 in the first wave, then there would not have been available worker resources for unloading incoming widget shipment E until time 2. This may have delayed the loading of outgoing shipment D. As a result, even though a shipment may be high priority, it may be scheduled later based on penalties for early shipment or other factors. In addition, even though a shipment may be lower priority, it may be scheduled earlier due to inventory shortages or other factors. As a result, a shipment priority, such as determined in step 520 above, may not be determinative of the order of shipments. In addition, had outgoing shipment C been initially scheduled for time 0 to time 3, then a subsequent variable neighborhood search such as described with reference to steps 560 and 570 above may have moved outgoing shipment C to a later time. That is, a variable neighborhood search may identify that loading of outgoing shipment D may have been delayed due to a lack of widgets and incoming shipment E may be available for unloading earlier. As a result, the variable neighborhood search as described with reference to steps 560 and 570 may resolve the schedule such that outgoing shipment C is pushed back in time to allow for incoming shipment E to be unloaded earlier, thereby providing sufficient widgets for outgoing shipments C and D.

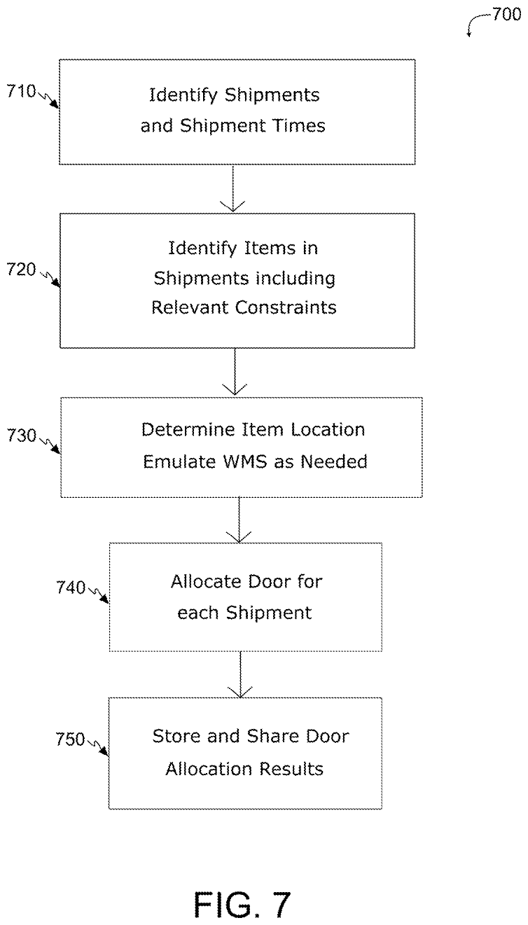

FIG. 7 depicts a flow diagram 700 of spatial assignment module 260 spatially optimizing the generated set of shipments, in which various embodiments of the present disclosure may be implemented. The description of FIG. 7 may reference elements of other Figures described herein. In this process, spatial assignment module 260 may optimize the distribution warehouse door utilized for loading or unloading each scheduled shipment (i.e., outgoing and incoming shipments including reallocation or transfer shipments). The door assigned for a given shipment may be based on the current and anticipated location of inventory needed for fulfilling that shipment, whether for picking or for storing items of that shipment.

In the present embodiment, spatial assignment module 260 may perform the processes described with reference to FIG. 7 just after sequence actor assignment module 250 optimizes a schedule of shipments (i.e., on an hourly or other periodic basis to update and optimize this planned schedule) to quickly adapt to changing conditions. Alternatively, spatial assignment module 260 may perform the processes described with reference to FIG. 7 upon a threshold of changes to ongoing conditions, such as upon changes shipment scheduling order or changes in inventory, labor, equipment, customer orders and other changes which may affect the schedule. Other possible times for spatial assignment module 260 to perform these processes may be known to one of ordinary skill in the art.

In a first step 710, the scheduled shipments, such as by optimizer 250, are identified including the start time allocated for moving a trailer or other shipping container to a door of the distribution warehouse for loading and/or unloading a shipment and an end time for removing the trailer from the door of the distribution warehouse, whether to a parking lot or on the road to a customer or other destination. This start time and end time, as may be scheduled by optimizer 250, collectively indicate a docking time period of the trailer at a door of the distribution warehouse. Alternatively, the start and end times for loading and/or unloading the trailer may be utilized with a buffer added for bring the trailer to the distribution warehouse door and for removing that trailer from the distribution warehouse door. Loading start and end times may include picking inventory, moving that picked inventory to a staging area, and then loading the storage container from the staging area. Unloading start and end times may include unloading a storage container to a staging area and storing the unloaded items away in distribution warehouse inventory. In the case of a trailer being unloaded and loaded, both sets of start and end times may be included to provide an accumulated start and end time.

Then in step 720, the items included in each shipment to be unloaded and/or loaded may be identified and associated with the respective shipment. This may include any constraints with regards to each item for each shipment such as item age requirements (i.e., some customers may have more strict or lax requirements regarding the acceptable age of items for shipment).

In step 730, work management system 295 may be emulated to determine current of planned locations in the distribution warehouse of the items associated with each shipment. That is, for each shipment, a current or future location for each shipment item may be identified. This may be performed in the order of shipment time period in order to take into account inventory being removed from one location and then added to another location by a subsequent shipment. That is, as inventory of an item is depleted in one location by an outgoing shipment, it may be added to a second location by a subsequent incoming shipments, and then picked from that second location by another outgoing shipment. Work management systems in general are fairly simple in implementation, so the underlying rules utilized by a given work management system may be quite easy to emulate. For example, in the case of a set of items stored at two different locations, the work management systems will typically direct the picker to pick from the location with the older items for a given shipment so long as the age of the older items are within an acceptable age for the shipment customer. This process may be continued for each shipment scheduled by optimizer 250 as identified in step 710 above.

Given the location of items to be stored and/or picked for each scheduled incoming and outgoing shipment, including reallocations and transfers, each scheduled shipment is allocated a distribution warehouse door for docking in step 740. It is noted that the same door may be allocated to multiple shipments so long as the scheduled times at that door do not overlap in time. This door allocation may be solved concurrently for all scheduled shipments utilizing a linear programming model. Alternatively, a learning system such as an artificial intelligence engine may be utilized. This solution may be based on minimizing (i.e., reducing) the overall travel distance between door allocation and the identified location for storing and/or picking items for all shipments. That is, the travel distance for storing or picking items for each shipment is accumulated with the travel distance for all other shipments for a minimized total travel distance. Such a travel distance minimization may be weighted more heavily for near term shipments versus shipments further in the future. Certain penalties for excessive travel distance may be utilized so as to avoid some shipments being late due to excess distance. Alternatively, any shipments with excessive travel distances may be given a higher priority for scheduling in FIG. 5 above.

In step 750, the results of the door allocation may be stored in historical data and the allocated doors reserved for use by the associated shipments. The results of this door allocation may be provided to a user for manual modifications due to conditions which may be unforeseen by the spatial assignment module. For example, a given distribution warehouse door may not be available due to a recent spill or other unexpected issue. Of course, one of ordinary skill in the art may appreciate alternative embodiments and implementations of this door allocation process.

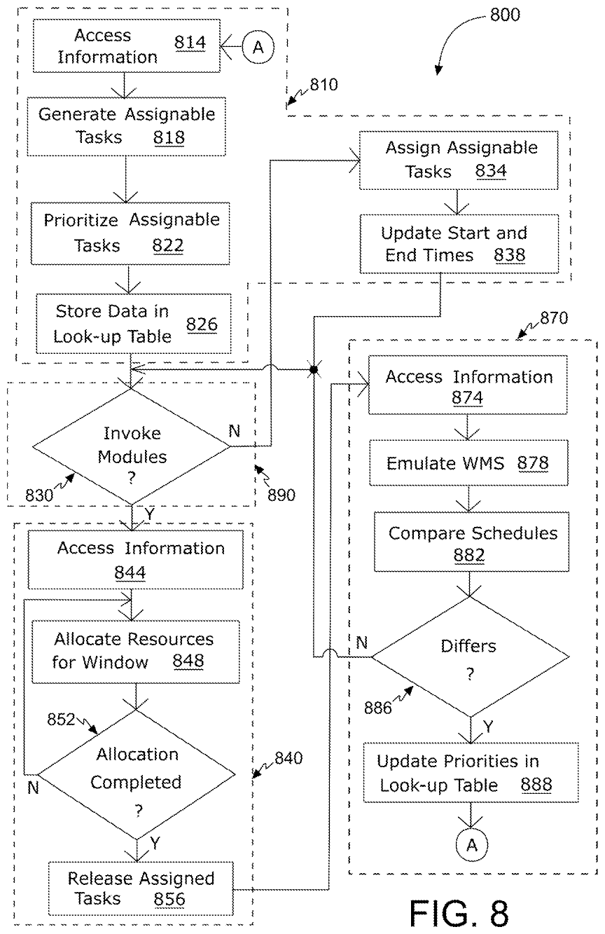

FIG. 8 depicts a flow diagram 800 of schedule execution module 270 implementing a planned schedule for managing operations of a distribution warehouse to handle incoming and outgoing shipments including reallocations and transfers, in which various embodiments of the present disclosure may be presented. This depiction includes a flow diagram of mission creation and awareness module 280, work queue tasking module 290 and work management system 295, as managed by management module 297, implementing a planned schedule such as from schedule planning module 220. In the present embodiment, WMS 295 is a third party software system whereby there may be limitations in directly modifying its functionality to implement the results of the actions of mission creation and awareness module 280 and work queue tasking module. As a result, priority settings in the WMS look-up table 296 may be massaged or otherwise updated so as to implement the results of the other modules of schedule execution module 270, such as described below. In alternative embodiments, WMS 295 may be customized or otherwise modified or supplemented so as to more directly implement the results of the other modules within schedule execution module 270. The description of FIG. 8 may reference elements of other Figures described herein.

Mission creation and awareness module 280, work queue tasking module 290 and WMS 295 may be invoked each time an updated planned schedule is provided by schedule planning module 220 (e.g., hourly). Mission creation and awareness module 280 and work queue tasking module 290 may also be invoked multiple times between updated planned schedules to provide updated inputs to work management system (WMS) 295 so that the WMS implements the planned schedule essentially as planned. For example, modules 280 and 290 may be invoked about every 5 minutes to adapt to ongoing changing conditions so that WMS 295 continues to essentially follow the updated planned schedule. In addition, when invoked, the modules of schedule execution module 295 may look ahead for a period of time less than the planned schedule. For example, the planned schedule may look ahead 24 to 48 hours or so for planning the scheduling of shipments (i.e., the planned schedule time period) whereas the modules of schedule execution module 295 may only look ahead 6 to 12 hours or so when implementing the planned schedule, which is referred to herein as an execution schedule time period.

As described above, in the present embodiment WMS 295 is an existing third party software tool utilized to direct the actions of labor resources and equipment in detail, which may be referred to as directed work in some distribution warehouses. There are several third party WMS products, each of which may be implemented or otherwise configured quite differently for each distribution warehouse. These WMS products are often quite adaptable and reactive to changing conditions, which could lead to excursions from the planned schedule. Such excursions may lead to large variations from the planned schedule over time between updated planned schedules. As a result, mission creation and awareness module 280 and work queue tasking module 290 may be invoked frequently, such as every 5 minutes or so, to help prevent WMS 295 from deviating significantly from the planned schedule. This implementation of a planned schedule may be performed by schedule execution module 270 such as described below.

In FIG. 8, the steps provided are grouped with dashed lines according to the module that may perform those steps. The steps in group 810 (steps 814, 818, 822, 826, 834 and 838) may be performed by WMS 295, the steps in group 840 (steps 844, 848, 852 and 856) may be performed by mission creation and awareness module 280, the steps in group 870 (steps 874, 878, 882, 886 and 888) may be performed by work queue tasking module 290, and the steps in group 890 (step 830) may be performed by management module 297. Alternative embodiments may organize the various steps and functions therein differently.

In a first step 814, the WMS may access an updated planned calendar for each task of each scheduled shipment including a scheduled start time and a scheduled end time, man hours or other workload measure needed to perform the associated task, space resources needed such as whether a staging area is needed, equipment needed to perform the associated task as well as any cuts to customer orders and cross-docks. This may include the current status of shipments in process of being loaded and/or unloaded. The WMS may also access associated customer orders corresponding to each shipment to determine the items to be picked or unloaded from each shipment. Then in step 818, the WMS generates a set of assignable tasks (i.e., sub-tasks) to complete each task of each shipment including an inventory location of each item being picked and/or stored away in inventory. In step 822, the WMS prioritizes the assignable tasks utilizing a priority score from look-up table 296 indicating an order of performing those assignable tasks as well as providing threshold priority differentials for a given labor resource (e.g., worker) to perform a task outside a given zone or area that the worker may be assigned to or currently located. The priority for each task may be based on whether the assignable is early, on time, or late. In some third party WMS implementations, a higher priority number may indicate a lower priority and vice versa. Then in step 826, the assignable tasks for each shipment and associated priorities for each assignable task may be stored or otherwise updated in look-up table 296 or other database for use by the WMS when assigning the assignable tasks to workers as described below.

In step 830, management module 297 may determine whether mission creation and awareness module 280 as well as work queue tasking module 290 should be invoked at this time. Each time there is a new planned schedule, then the other modules should be invoked. In addition, if a given time has passed since the last invocation of the other modules, or if certain thresholds have been met indicating that the WMS is deviating significantly from the planned schedule, then the other modules should be invoked. That is, if yes, then processing continues to step 844, otherwise processing continues to step 834.

In step 834, WMS 295 then assigns the assignable tasks as needed to the available labor and equipment resources, according to the provided priorities in look-up table 296 given inventory and other applicable location of the assignable task. The applicable priority for each assignable task in the look-up table depends on whether a given task is early, on time or late as described above. As each assignable task is completed, that may be indicated in or removed from the look-up table. Then, in step 838, the WMS may update the relative (to the current time) priority for each assigned task as those tasks are processed or otherwise worked on by the applicable labor and equipment resources. The WMS may update the priority for each assignable task based on whether a certain amount of time has passed since a prior such update. This will allow the WMS to quickly determine the applicable priority for each assignable task based on whether that task is early, on time or late. Whether or not the WMS has updated the priority for each assignable task, processing returns to step 830 described above. Steps 830, 834 and 838 may be repeated until such time as a new planned schedule is provided by schedule planning module 250, in which case the processes described with reference to FIG. 8 may be performed again starting with step 814.

In step 844, mission creation and awareness module 280 may access information regarding the planned schedule from database 210 including, for each task of each scheduled shipment, a scheduled start time and a scheduled end time, man hours or other workload measure needed to perform the associated task, space resources needed such as whether a staging area is needed, as well as equipment needed to perform the associated task. In addition, module 280 may obtain information regarding existing (currently available) labor and equipment resources during the execution schedule time period from database 210, including any assigned zones and areas of those resources within the distribution warehouse. Furthermore, module 280 may obtain information from WMS look-up table 296 regarding the currently scheduled assignable tasks. Other information that may be needed may be obtained from database 210. Then in step 848, mission creation and awareness module 280 identifies and allocates the appropriate and currently available labor and equipment resources for implementing the currently scheduled assignable tasks for a limited time window of the execution schedule time period. This resource identification may take into account the assigned locations of each of the labor and equipment resources and the location of ordered items within the distribution warehouse, including utilizing this information to minimize travel distance by the labor and equipment resources for the assignable tasks within the distribution warehouse. The limited time window may be a subset of the execution schedule time period, starting with the current time. In step 852, it is determined whether module 280 has completed assigning or otherwise allocating available labor and equipment resources to the assignable tasks for the full execution schedule time period. If not, then processing returns to step 848 to assign resources for the next time window, otherwise processing continues to step 856. In step 856, upon completion of the allocation of task assignments to labor and equipment resources, the assigned tasks may be released into a WMS work queue and stored in database 210. Processing then continues to step 874.

In step 874, work queue tasking module 290 may obtain information regarding the planned schedule from database 210 including, for each task of each scheduled shipment, a scheduled start time and a scheduled end time, man hours or other workload measure needed to perform the associated task, space resources needed such as whether a staging area is needed, as well as equipment needed to perform the associated task. In addition, module 280 may obtain information from WMS look-up table 296 regarding the currently scheduled assignable tasks. Furthermore, module 280 may obtain information regarding assigned labor and equipment resources for assigned tasks during the execution schedule time period from mission creation and awareness module 280. Other information that may be needed may be obtained from database 210.

Then in step 878, work queue tasking module 290 emulates the actions of WMS 295 given the current assigned tasks and priorities in WMS look-up table 296 to determine an expected schedule, including assigned labor and equipment resources, that those assigned tasks will be completed for a period of time from the present to a predesignated amount of time in the future (i.e., an expected schedule time period). In step 882, module 290 compares the expected schedule with the planned schedule from schedule planning module 220 as well as the assigned labor and equipment resources from mission creation and awareness module 280. In step 886, work queue tasking module 290 determines whether the expected schedule differs from the planned schedule and assigned resources significantly (i.e., greater than a predetermined differential threshold). If yes, then processing continues to step 888, otherwise processing returns to step 830. In step 888, work queue tasking module 290 may then modify or otherwise update the priorities of the assigned tasks in WMS look-up table 296 so that the WMS will execute those assigned tasks according to the planned schedule and utilizing the assigned labor and equipment resources. Once step 888 has completed, processing returns to step 814 above for the WMS to implement the planned schedule utilizing the updated look-up table.

Throughout the processes described with reference to FIG. 8, the operation of modules 280, 290 and 295 may be managed by management module 297. That is, management module may coordinate the activities of modules 280 and 290 with WMS 295, such as the length of time they schedule forward, as well as manage their inputs and outputs. For example, as coordinated by management module 297, schedule execution module 270 may be utilized on demand of a user to modify certain planned tasks when implementing a planned schedule. In an alternative embodiment, management module 297 may include one or more learning systems such as artificial intelligence engines to manage the inputs and/or outputs of the various modules. For example, an artificial intelligence engine may be trained over time to adjust certain planned tasks by schedule planning module based on prior experience of shipments based on time of year, supplier, etc. Management module 297 may also utilize prior results of schedule execution module 270 to adjust expected task completion timing and other factors utilized by task creation module or the other modules. Management module 297 may also provide additional management functions towards implementing new features and capabilities of the other modules. In an alternative embodiment, management modules 265 and 297 may be combined into a single management module.

As may be appreciated by one of ordinary skill in the art, many alternative embodiments may be implemented without departing from the scope and spirit of the described embodiments. For example, work management system 295 may be customized or otherwise configured to work more directly with the equipment and interfaces throughout the warehouse site or campus before implementation of the present embodiment.

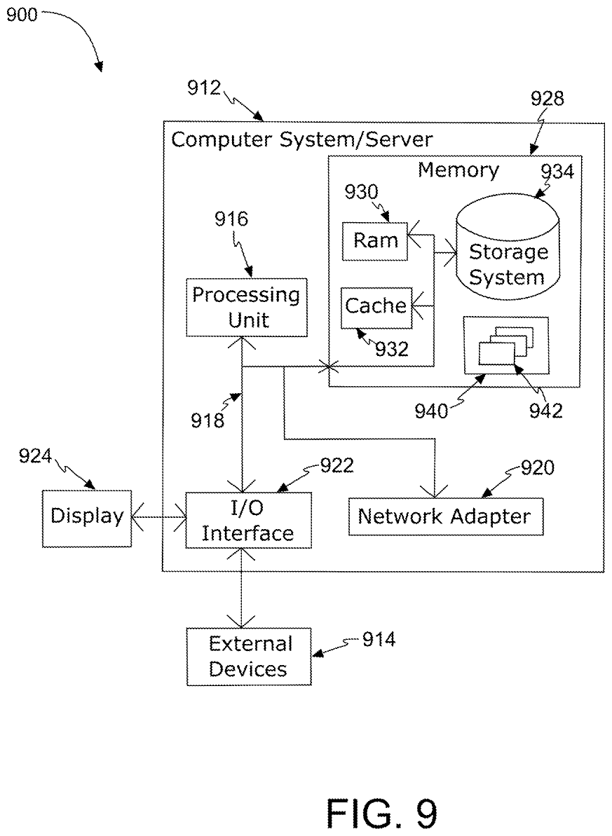

FIG. 9 depicts a block diagram of an illustrative data processing system in which various embodiments of the present disclosure may be implemented. Data processing system 900 is one example of a suitable data processing system and is not intended to suggest any limitation as to the scope of use or functionality of the embodiments described herein. Regardless, data processing system 900 is capable of being implemented and/or performing any of the functionality set forth herein such as automatically and dynamically planning and executing distribution warehouse scheduling and operations.

In data processing system 900 there is a computer system/server 912, which is operational with numerous other computing system environments, peripherals, or configurations. Examples of well-known computing systems, environments, and/or configurations that may be suitable for use with computer system/server 912 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 912 may be described in the general context of computer system-performable instructions, such as program modules, being processed by a computer system. Generally, program modules may include routines, programs, objects, components, logic, data structures, and so on that perform particular tasks or implement particular abstract data types. Computer system/server 912 may be practiced in distributed computing environments where tasks are performed by remote processing devices that are linked through a communications network. In a distributed computing environment, program modules may be located in both local and remote computer system storage media including memory storage devices. For example, various embodiments of the systems and methods such as described herein may be implemented in a cloud computing environment, distributed or otherwise, which may be virtualized such as with the use of a hypervisor managing multiple nodes including virtual processors, virtual memory, etc.

As depicted in FIG. 9, computer system/server 912 in data processing system 900 is shown in the form of a general-purpose computing device. The components of computer system/server 912 may include, but are not limited to, one or more processors or processing units 916, a system memory 928, and a bus 918 that couples various system components including system memory 928 to processor 916.

Bus 918 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 912 typically includes a variety of non-transitory computer system usable media. Such media may be any available media that is accessible by computer system/server 912, and it includes both volatile and non-volatile media, removable and non-removable media.

System memory 928 may include non-transitory computer system readable media in the form of volatile memory, such as random access memory (RAM) 930 and/or cache memory 932. Computer system/server 912 may further include other non-transitory removable/non-removable, volatile/non-volatile computer system storage media. By way of example, storage system 934 can be provided for reading from and writing to a non-removable, non-volatile magnetic media (not shown and typically called a “hard drive”). Although not shown, a USB interface for reading from and writing to a removable, non-volatile magnetic chip (e.g., a “flash drive”), and an optical disk drive for reading from or writing to a removable, non-volatile optical disk such as a CD-ROM, DVD-ROM or other optical media can be provided. In such instances, each can be connected to bus 918 by one or more data media interfaces. Memory 928 may include at least one program product having a set (e.g., at least one) of program modules that are configured to carry out the functions of the embodiments. Memory 928 may also include data that will be processed by a program product.

Program/utility 940, having a set (at least one) of program modules 942, may be stored in memory 928 by way of example, and not limitation, as well as an operating system, one or more application programs, other program modules, and program data. Each of the operating system, one or more application programs, other program modules, and program data or some combination thereof, may include an implementation of a networking environment. Program modules 942 generally carry out the functions and/or methodologies of the embodiments. For example, a program module may be software for automatically and dynamically planning and executing distribution warehouse scheduling and operations.

Computer system/server 912 may also communicate with one or more external devices 914 such as a keyboard, a pointing device, a display 924, etc.; one or more devices that enable a user to interact with computer system/server 912; and/or any devices (e.g., network card, modem, etc.) that enable computer system/server 912 to communicate with one or more other computing devices. Such communication can occur via I/O interfaces 922 through wired connections or wireless connections. Still yet, computer system/server 912 can communicate with one or more networks such as a local area network (LAN), a general wide area network (WAN), and/or a public network (e.g., the Internet) via network adapter 920. As depicted, network adapter 920 communicates with the other components of computer system/server 912 via bus 918. It should be understood that although not shown, other hardware and/or software components could be used in conjunction with computer system/server 912. Examples, include, but are not limited to: microcode, device drivers, tape drives, RAID systems, redundant processing units, data archival storage systems, external disk drive arrays, etc.

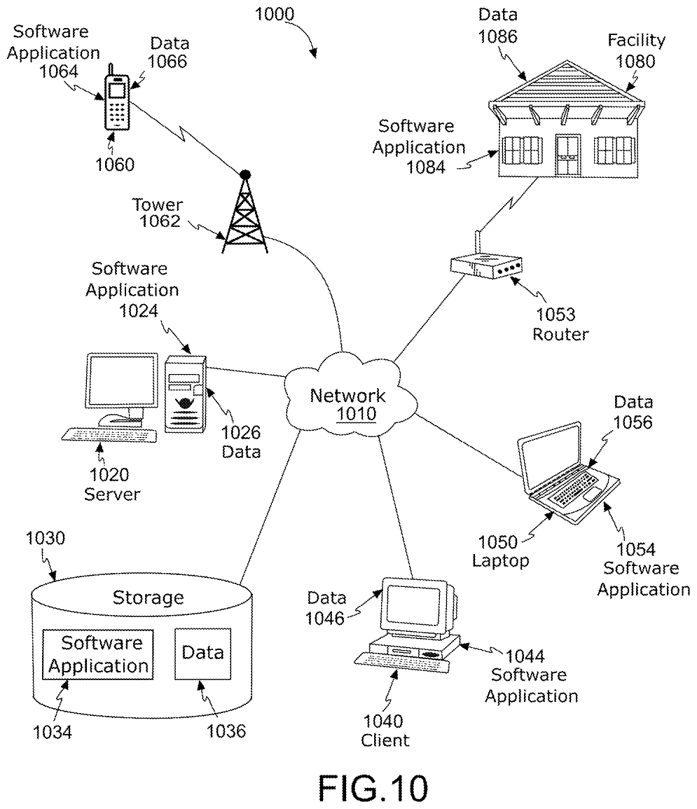

FIG. 10 depicts a block diagram of an illustrative network of data processing systems in which various embodiments of the present disclosure may be implemented. Data processing environment 1000 is a network of data processing systems such as described above with reference to FIG. 9. Software applications such as for automatically and dynamically planning and executing distribution warehouse scheduling and operations may be processed on any computer or other type of data processing system in data processing environment 1000. Data processing environment 1000 includes network 1010. Network 1010 is the medium used to provide simplex, half duplex and/or full duplex communications links between various devices and computers connected together within data processing environment 1000. Network 1010 may include connections such as wire, wireless communication links, or fiber optic cables.

Server 1020 and client 1040 are coupled to network 1010 along with storage unit 1030. In addition, laptop 1050 and facility 1080 (such as a home or business) are coupled to network 1010 including wirelessly such as through a network router 1053. A mobile device 1060 such as a mobile phone may be coupled to network 1010 through a cell tower 1062. Data processing systems, such as server 1020, client 1040, laptop 1050, mobile device 1060 and facility 1080 contain data and have software applications including software tools processing thereon. Other types of data processing systems such as personal digital assistants (PDAs), smartphones, tablets and netbooks may be coupled to network 1010.

Server 1020 may include software application 1024 and data 1026 for automatically and dynamically planning and executing distribution warehouse scheduling and operations or other software applications and data in accordance with embodiments described herein. Storage 1030 may contain software application 1034 and a content source such as data 1036 for automatically and dynamically planning and executing distribution warehouse scheduling and operations. Other software and content may be stored on storage 1030 for sharing among various computer or other data processing devices. Client 1040 may include software application 1044 and data 1046. Laptop 1050 and mobile device 1060 may also include software applications 1054 and 1064 and data 1056 and 1066. Facility 1080 may include software applications 1084 and data 1086 on local data processing equipment. Other types of data processing systems coupled to network 1010 may also include software applications. Software applications could include a web browser, email, or other software application for automatically and dynamically planning and executing distribution warehouse scheduling and operations.

Server 1020, storage unit 1030, client 1040, laptop 1050, mobile device 1060, and facility 1080 and other data processing devices may couple to network 1010 using wired connections, wireless communication protocols, or other suitable data connectivity. Client 1040 may be, for example, a personal computer or a network computer.

In the depicted example, server 1020 may provide data, such as boot files, operating system images, and applications to client 1040 and laptop 1050. Server 1020 may be a single computer system or a set of multiple computer systems working together to provide services in a client server environment. Client 1040 and laptop 1050 may be clients to server 1020 in this example. Client 1040, laptop 1050, mobile device 1060 and facility 1080 or some combination thereof, may include their own data, boot files, operating system images, and applications. Data processing environment 1000 may include additional servers, clients, and other devices that are not shown.

In the depicted example, data processing environment 1000 may be the Internet. Network 1010 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 1000 also may be implemented as a number of different types of networks, such as for example, an intranet, a local area network (LAN), or a wide area network (WAN). FIG. 10 is intended as an example, and not as an architectural limitation for the different illustrative embodiments.

Among other uses, data processing environment 1000 may be used for implementing a client server environment in which the embodiments may be implemented. A client server environment enables software applications and data to be distributed across a network such that an application functions by using the interactivity between a client data processing system and a server data processing system. Data processing environment 1000 may also employ a service oriented architecture where interoperable software components distributed across a network may be packaged together as coherent business applications.

Embodiments of the system and method for automatically and dynamically planning and executing distribution warehouse scheduling and operations may be implemented in any manner including as a computer program product at any possible technical detail level of integration. The computer program product may include a computer readable storage medium (or media) having computer readable program instructions thereon for causing a processor to carry out aspects of the embodiments of the system and method for automatically and dynamically planning and executing distribution warehouse scheduling and operations.

The computer readable storage medium can be a tangible device that can retain and store instructions for use by an instruction processing device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present system and method may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++ or the like, and procedural programming languages, such as the “C” programming language or other programming languages such as Java. The computer readable program instructions may be processed entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may process the computer readable program instructions by utilizing state information of the computer readable program instructions to personalize the electronic circuitry, in order to perform aspects of the system and method for automatically and dynamically planning and executing distribution warehouse scheduling and operations.

Aspects of the present system and method are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer or other programmable data processing apparatus to produce a special purpose machine, such that the instructions, which are processed via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operations to be performed on the computer, other programmable apparatus or other device to produce a computer implemented process, such that the instructions which are processed on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present system and method. In this regard, each block in the flowchart or block diagrams may represent a module, segment, or portion of instructions, which comprises one or more performable instructions for implementing the specified logical function(s). In some alternative implementations, the functions noted in the blocks may occur out of the order noted in the Figures. For example, two blocks shown in succession may, in fact, be processed substantially concurrently, or the blocks may sometimes be processed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A data processing system suitable for storing and/or processing program code will include at least one processor coupled directly or indirectly to memory elements through a system bus. The memory elements can include local memory employed during actual processing of the program code, bulk storage media, and cache memories, which provide temporary storage of at least some program code in order to reduce the number of times code must be retrieved from bulk storage media during processing.

A data processing system may act as a server data processing system or a client data processing system. Server and client data processing systems may include data storage media that are computer usable, such as being computer readable. A data storage medium associated with a server data processing system may contain computer usable code such as for automatically and dynamically planning and executing distribution warehouse scheduling and operations. A client data processing system may download that computer usable code, such as for storing on a data storage medium associated with the client data processing system, or for using in the client data processing system. The server data processing system may similarly upload computer usable code from the client data processing system such as a content source. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The descriptions of the various embodiments of the present system and method have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terminology used herein is for the purpose of describing particular embodiments and is not intended to be limiting of the present system and method. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or operations plus function elements in the claims below are intended to include any structure, material, or act for performing the function in combination with other claimed elements as specifically claimed. The description of the present system and method has been presented for purposes of illustration and description, but is not intended to be exhaustive or limited to the system and method for automatically and dynamically planning and executing distribution warehouse scheduling and operations in the form disclosed. Many modifications and variations will be apparent to those of ordinary skill in the art. The embodiment was chosen and described in order to best explain the principles of the system and method and the practical application, and to enable others of ordinary skill in the art to understand the system and method for various embodiments with various modifications as are suited to the particular use contemplated.

1. A data processing system for automatically and dynamically planning and executing task based scheduling and operations of a distribution warehouse locality, the data processing system comprising:
a processor; and
a memory storing program instructions which when processed by the processor perform the operations of:
accessing a set of customer orders for fulfillment from the distribution warehouse locality within a planned schedule time period, each customer order including a priority for fulfillment;
accessing current inventory levels for the distribution warehouse locality;
accessing expected shipments of inventory to the distribution warehouse locality;
accessing a set of expected labor resources at the distribution warehouse locality for fulfilling the set of customer orders within the planned schedule time period;
automatically generating a set of tasks for completing each customer order;
automatically optimizing an allocation of the set of tasks with the set of expected labor resources for each customer order;
automatically scheduling the allocated set of expected labor resources and the set of tasks for fulfilling the set of customer orders;
accessing an identified set of actors associated with the set of expected labor resources within an execution schedule time period;
automatically optimizing an allocation of the set of tasks with the identified set of actors for fulfilling the set of customer orders within the execution schedule time period, the optimization including reducing travel by the set of actors; and
automatically providing a set of signals describing the optimized allocated set of tasks to the identified set of actors.

2. The data processing system of claim 1 further comprising implementing the allocated set of tasks with the set of actors in response to the provided set of signals wherein the identified set of actors perform the allocated set of tasks.

3. The data processing system of claim 1 further comprising accessing an identified set of automated machines associated with the set of expected labor resources within the execution schedule time period; wherein the allocation of the set of tasks with the identified set of actors for fulfilling the set of customer orders within the execution schedule time period includes automatically optimizing the allocation of the set of tasks with the identified set of automated machines for fulfilling the set of customer orders.

4. The data processing system of claim 3 wherein the identified set of automated machines and the identified set of actors perform the allocated set of tasks in response to the provided set of signals.

5. The data processing system of claim 1 wherein the allocation of the set of tasks with the set of expected labor resources for each customer order is automatically updated; and wherein the allocation of the set of tasks with the identified set of actors for fulfilling the set of customer orders within the execution schedule time period is dynamically updated in response.

6. The data processing system of claim 5 wherein the allocation of the set of tasks with the set of labor resources for the set of customer orders is dynamically updated when incoming shipments are delayed.

7. The data processing system of claim wherein the allocation of the set of tasks with the set of labor resources for the set of customer orders is dynamically updated when a portion of the identified set of actors are missing.

8. A method of automatically and dynamically planning and executing task based scheduling and operations of a distribution warehouse locality, the method comprising:
accessing a set of customer orders for fulfillment from the distribution warehouse locality within a planned schedule time period, each customer order including a priority for fulfillment;
accessing current inventory levels for the distribution warehouse locality;
accessing expected shipments of inventory to the distribution warehouse locality;
accessing a set of expected labor resources at the distribution warehouse locality for fulfilling the set of customer orders within the planned schedule time period;
automatically generating a set of tasks for completing each customer order;
automatically optimizing an allocation of the set of tasks with the set of expected labor resources for each customer order;
automatically scheduling the allocated set of expected labor resources and the set of tasks for fulfilling the set of customer orders;
accessing an identified set of actors associated with the set of expected labor resources within an execution schedule time period;
automatically optimizing an allocation of the set of tasks with the identified set of actors for fulfilling the set of customer orders within the execution schedule time period, the optimization including reducing travel by the set of actors; and
automatically providing a set of signals describing the optimized allocated set of tasks to the identified set of actors.

9. The method of claim 8 further comprising implementing the allocated set of tasks with the set of actors in response to the provided set of signals wherein the identified set of actors perform the allocated set of tasks.

10. The method of claim 8 further comprising accessing an identified set of automated machines associated with the set of expected labor resources within the execution schedule time period; wherein the allocation of the set of tasks with the identified set of actors for fulfilling the set of customer orders within the execution schedule time period includes automatically optimizing the allocation of the set of tasks with the identified set of automated machines for fulfilling the set of customer orders.

11. The method of claim 10 wherein the identified set of automated machines and the identified set of actors perform the allocated set of tasks in response to the provided set of signals.

12. The method of claim 8 wherein the allocation of the set of tasks with the set of expected labor resources for each customer order is automatically updated; and wherein the allocation of the set of tasks with the identified set of actors for fulfilling the set of customer orders within the execution schedule time period is dynamically updated in response.

13. The method of claim 12 wherein the allocation of the set of tasks with the set of labor resources for the set of customer orders is dynamically updated when incoming shipments are delayed.

14. The method of claim 12 wherein the allocation of the set of tasks with the set of labor resources for the set of customer orders is dynamically updated when a portion of the identified set of actors are missing.

15. A computer program product for automatically and dynamically planning and executing task based scheduling and operations of a distribution warehouse locality, the computer program product comprising a computer readable storage medium having program instructions embodied therewith, the program instructions processed by a processing circuit to cause the device to perform a method comprising the operations of:
accessing a set of customer orders for fulfillment from the distribution warehouse locality within a planned schedule time period, each customer order including a priority for fulfillment;
accessing current inventory levels for the distribution warehouse locality;
accessing expected shipments of inventory to the distribution warehouse locality;
accessing a set of expected labor resources at the distribution warehouse locality for fulfilling the set of customer orders within the planned schedule time period;
automatically generating a set of tasks for completing each customer order;
automatically optimizing an allocation of the set of tasks with the set of expected labor resources for each customer order;
automatically scheduling the allocated set of expected labor resources and the set of tasks for fulfilling the set of customer orders;
accessing an identified set of actors associated with the set of expected labor resources within an execution schedule time period;
automatically optimizing an allocation of the set of tasks with the identified set of actors for fulfilling the set of customer orders within the execution schedule time period, the optimization including reducing travel by the set of actors; and
automatically providing a set of signals describing the optimized allocated set of tasks to the identified set of actors.

16. The computer program product of claim 15 further comprising implementing the allocated set of tasks with the set of actors in response to the provided set of signals wherein the identified set of actors perform the allocated set of tasks.

17. The computer program product of claim 15 further comprising accessing an identified set of automated machines associated with the set of expected labor resources within the execution schedule time period; wherein the allocation of the set of tasks with the identified set of actors for fulfilling the set of customer orders within the execution schedule time period includes automatically optimizing the allocation of the set of tasks with the identified set of automated machines for fulfilling the set of customer orders.

18. The computer program product of claim 17 wherein the identified set of automated machines and the identified set of actors perform the allocated set of tasks in response to the provided set of signals.

19. The computer program product of claim 15 wherein the allocation of the set of tasks with the set of expected labor resources for each customer order is automatically updated; and wherein the allocation of the set of tasks with the identified set of actors for fulfilling the set of customer orders within the execution schedule time period is dynamically updated in response.

20. The computer program product of claim 19 wherein the allocation of the set of tasks with the set of labor resources for the set of customer orders is dynamically updated when incoming shipments are delayed.

21. The data processing system of claim 1 further comprising:
accessing a set of equipment resources at the distribution warehouse locality for fulfilling the set of customer orders within the planned schedule time period;
wherein automatically optimizing includes automatically optimizing an allocation of the set of tasks with the set of expected labor resources and the set of equipment resources for each customer order;
wherein automatically scheduling includes automatically scheduling the allocated set of expected labor resources, the set of equipment resources, and the set of tasks for fulfilling the set of customer orders;
wherein accessing an identified set of actors includes accessing an identified set of actors associated with the set of expected labor resources and an identified set of equipment associated with the set of equipment resources, within the execution schedule time period; and
wherein automatically optimizing includes automatically optimizing an allocation of the set of tasks with the identified set of actors and the identified set of equipment for fulfilling the set of customer orders within the execution schedule time period, the optimization including reducing travel by the set of actors.

22. The method of claim 8 further comprising:
accessing a set of equipment resources at the distribution warehouse locality for fulfilling the set of customer orders within the planned schedule time period;
wherein automatically optimizing includes automatically optimizing an allocation of the set of tasks with the set of expected labor resources and the set of equipment resources for each customer order;
wherein automatically scheduling includes automatically scheduling the allocated set of expected labor resources, the set of equipment resources, and the set of tasks for fulfilling the set of customer orders;
wherein accessing an identified set of actors includes accessing an identified set of actors associated with the set of expected labor resources and an identified set of equipment associated with the set of equipment resources, within the execution schedule time period; and
wherein automatically optimizing includes automatically optimizing an allocation of the set of tasks with the identified set of actors and the identified set of equipment for fulfilling the set of customer orders within the execution schedule time period, the optimization including reducing travel by the set of actors.

23. The computer program product of claim 16 further comprising:
accessing a set of equipment resources at the distribution warehouse locality for fulfilling the set of customer orders within the planned schedule time period;
wherein automatically optimizing includes automatically optimizing an allocation of the set of tasks with the set of expected labor resources and the set of equipment resources for each customer order;
wherein automatically scheduling includes automatically scheduling the allocated set of expected labor resources, the set of equipment resources, and the set of tasks for fulfilling the set of customer orders;
wherein accessing an identified set of actors includes accessing an identified set of actors associated with the set of expected labor resources and an identified set of equipment associated with the set of equipment resources, within the execution schedule time period; and
wherein automatically optimizing includes automatically optimizing an allocation of the set of tasks with the identified set of actors and the identified set of equipment for fulfilling the set of customer orders within the execution schedule time period, the optimization including reducing travel by the set of actors.
